(19) United States
(12) Patent Application Publication
(10) Pub. No.: US 2024/0120987 A1
(43) Pub. Date: Apr. 11, 2024

(54) CONFIGURATION FOR USER EQUIPMENT COOPERATION

(71) Applicant: QUALCOMM Incorporated, San Diego, CA (US)

(72) Inventors: Fang YUAN, Beijing (CN); Aleksandar DAMNJANOVIC, Del Mar, CA (US); Yan ZHOU, San Diego, CA (US); Tao LUO, San Diego, CA (US); Xiaoxia ZHANG, San Diego, CA (US)

(21) Appl. No.: 18/546,078

(22) PCT Filed: Apr. 23, 2021
(86) PCT No.: PCT/CN2021/089292

§ 371 Date: Aug. 10, 2023

(51) Int. Cl. H04B 7/08

(52) U.S. Cl. CPC H04B 7/0874

(57) ABSTRACT

Methods, systems, and devices for wireless communications are described. In some examples, a first user equipment (UE) may receive an active communication configuration between the first UE and a base station. The first UE may receive a UE cooperation configuration between at least the first UE and a second UE. The UE cooperation configuration may include a configuration for communicating messages between the base station and a set of antenna panels corresponding to at least the first UE and the second UE as a single entity. The UE cooperation configuration may include parameters associated with the second UE. The first UE may identify, from the set of antenna panels, an antenna panel for reception of a downlink message based on the UE cooperation configuration. The first UE may transmit a message to the base station, the second UE, or both in response to the downlink message.

### CROSS REFERENCE

The present Application is a 371 national stage filing of International PCT Application No. PCT/CN2021/089292 by YUAN et al. entitled “CONFIGURATION FOR USER EQUIPMENT COOPERATION,” filed Apr. 23, 2021, which is assigned to the assignee hereof, and which is expressly incorporated by reference in its entirety herein.

### FIELD OF TECHNOLOGY

The following relates to wireless communications, including configuration for user equipment (UE) cooperation.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations or one or more network access nodes, each simultaneously supporting communication for multiple communication devices, which may be otherwise known as user equipment (UE).

In some wireless communications systems, a UE may communicate with a network node such as a base station using one or more antenna panels that are co-located on the UE. Such techniques may limit network throughput and increase latency if there is interference between the UE and the network node.

### SUMMARY

The described techniques relate to improved methods, systems, devices, and apparatuses that support configuration for user equipment (UE) cooperation. Generally, the described techniques provide for a first UE to receive a configuration for cooperating with one or more other UEs. The first UE may receive, from a base station, an active communication configuration between the first UE and the base station. The first UE may subsequently receive, from the base station, a UE cooperation configuration between the first UE and at least a second UE. The UE cooperation configuration may include a configuration for communicating messages between the base station and a set of antenna panels corresponding to at least the first UE and the second UE. The set of antenna panels may be configured as a single entity according to the UE cooperation configuration. For example, the set of antenna panels may be configured as a single radio resource control (RRC) entity from the perspective of the network, even though the antenna panels are distributed across separate individual UEs. In some examples, the UE cooperation configuration may include an identifier (ID) of the second UE and at least a portion of an active communication configuration between the second UE and the base station. While performing UE cooperation, the first UE may identify, from the set of antenna panels corresponding to at least the first UE and the second UE, an antenna panel for reception of a downlink message from the base station based on the UE cooperation configuration. The first UE may identify the antenna panel based on a grant received from the base station, the ID of the second UE, an ID of the first UE, or any combination thereof. The first UE or the second UE may receive the downlink message via the identified antenna panel of the set of antenna panels, and the first UE may transmit a message (e.g., a feedback message) to the base station, to the second UE, or both in response to the downlink message.

A method for wireless communications at a first UE is described. The method may include receiving, from a base station, first control signaling indicating an active communication configuration between the first UE and the base station, receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, identifying, from the set of multiple antenna panels, an antenna panel for reception of a downlink message from the base station based on the UE cooperation configuration, and transmitting a message to the base station, the second UE, or both in response to the downlink message and in accordance with the UE cooperation configuration.

An apparatus for wireless communications at a first UE is described. The apparatus may include a processor, memory coupled with the processor, and instructions stored in the memory. The instructions may be executable by the processor to cause the apparatus to receive, from a base station, first control signaling indicating an active communication configuration between the first UE and the base station, receive, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, identify, from the set of multiple antenna panels, an antenna panel for reception of a downlink message from the base station based on the UE cooperation configuration, and transmit a message to the base station, the second UE, or both in response to the downlink message and in accordance with the UE cooperation configuration.

Another apparatus for wireless communications at a first UE is described. The apparatus may include means for receiving, from a base station, first control signaling indicating an active communication configuration between the first UE and the base station, means for receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, means for identifying, from the set of multiple antenna panels, an antenna panel for reception of a downlink message from the base station based on the UE cooperation configuration, and means for transmitting a message to the base station, the second UE, or both in response to the downlink message and in accordance with the UE cooperation configuration.

A non-transitory computer-readable medium storing code for wireless communications at a first UE is described. The code may include instructions executable by a processor to receive, from a base station, first control signaling indicating an active communication configuration between the first UE and the base station, receive, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, identify, from the set of multiple antenna panels, an antenna panel for reception of a downlink message from the base station based on the UE cooperation configuration, and transmit a message to the base station, the second UE, or both in response to the downlink message and in accordance with the UE cooperation configuration.

In some examples of the method, apparatuses, and non-transitory computer-readable medium described herein, identifying the antenna panel from the set of multiple antenna panels may include operations, features, means, or instructions for receiving, from the base station, a grant scheduling the downlink message, where the grant indicates an ID of the first UE or the ID of the second UE and identifying, from a first antenna panel corresponding to the first UE and a second antenna panel corresponding to the second UE, the antenna panel for reception of the downlink message in accordance with the grant.

In some examples of the method, apparatuses, and non-transitory computer-readable medium described herein, receiving the grant may include operations, features, means, or instructions for receiving downlink control information (DCI) including a cell index field (CIF) set to a first value corresponding to the ID of the first UE or a second value corresponding to the ID of the second UE and identifying the antenna panel in accordance with the CIF.

In some examples of the method, apparatuses, and non-transitory computer-readable medium described herein, receiving the grant may include operations, features, means, or instructions for receiving DCI including cyclic redundancy check (CRC) information scrambled by a first control radio network temporary identifier (C-RNTI) corresponding to the ID of the first UE or scrambled by a second C-RNTI corresponding to the ID of the second UE and identifying the antenna panel in accordance with the first C-RNTI or the second C-RNTI.

In some examples of the method, apparatuses, and non-transitory computer-readable medium described herein, the grant indicates the ID of the first UE and the method, apparatuses, and non-transitory computer-readable medium may include further operations, features, means, or instructions for receiving the downlink message at the first antenna panel corresponding to the first UE in accordance with the grant and transmitting, to the base station, the message in response to the downlink message, where the message includes a feedback message corresponding to the downlink message.

In some examples of the method, apparatuses, and non-transitory computer-readable medium described herein, the active communication configuration between the first UE and the base station includes an RRC configuration between the first UE and the base station, the active communication configuration between the second UE and the base station includes an RRC between the second UE and the base station, the second control signaling includes an RRC reconfiguration message indicating the ID of the second UE and the portion of the active communication configuration between the second UE and the base station, and the portion of the active communication configuration between the second UE and the base station includes a DCI format corresponding to the second UE, a type of the RRC configuration between the second UE and the base station, or both.

In some examples of the method, apparatuses, and non-transitory computer-readable medium described herein, the ID of the second UE includes one of a C-RNTI, an antenna panel ID, a serving cell index, a control resource set (CORESET) ID, or a component carrier ID.

In some examples of the method, apparatuses, and non-transitory computer-readable medium described herein, the type of the RRC configuration between the second UE and the base station includes a downlink shared channel configuration, a downlink control channel configuration, an uplink shared channel configuration, an uplink control channel configuration, or a combination thereof.

Some examples of the method, apparatuses, and non-transitory computer-readable medium described herein may further include operations, features, means, or instructions for receiving activation signaling indicating an activation of UE cooperation between the first UE and the second UE in accordance with the UE cooperation configuration, where the activation signaling includes a first field indicating the activation of the UE cooperation, a second field indicating an ID of the first UE and the ID of the second UE, a third field indicating a type of the UE cooperation to be activated, or a combination thereof and communicating, in response to the activation signaling, with the base station, with the second UE, or both in accordance with the UE cooperation configuration.

Some examples of the method, apparatuses, and non-transitory computer-readable medium described herein may further include operations, features, means, or instructions for receiving deactivation signaling indicating a deactivation of the UE cooperation between the first UE and the second UE, where the deactivation signaling includes the first field indicating the deactivation of the UE cooperation, the second field indicating the ID of the first UE and the ID of the second UE, the third field indicating the type of the UE cooperation to be deactivated, or a combination thereof.

In some examples of the method, apparatuses, and non-transitory computer-readable medium described herein, the type of the UE cooperation corresponds to cooperation for uplink communications, downlink communications, communications via an uplink control channel, communications via a downlink control channel, or a combination thereof.

Some examples of the method, apparatuses, and non-transitory computer-readable medium described herein may further include operations, features, means, or instructions for receiving the activation signaling via a first medium access control control element (MAC-CE) and receiving the deactivation signaling via a second MAC-CE.

Some examples of the method, apparatuses, and non-transitory computer-readable medium described herein may further include operations, features, means, or instructions for transmitting, to the base station, a request for UE cooperation with the second UE in accordance with a UE cooperation negotiation procedure performed between the first UE and the second UE and receiving the second control signaling in response to transmitting the request for UE cooperation.

A method for wireless communications at a base station is described. The method may include transmitting, to a first UE, first control signaling indicating an active communication configuration between the first UE and the base station, transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, and transmitting, to the first UE using an antenna panel of the set of multiple antenna panels, a downlink message in accordance with the UE cooperation configuration.

An apparatus for wireless communications at a base station is described. The apparatus may include a processor, memory coupled with the processor, and instructions stored in the memory. The instructions may be executable by the processor to cause the apparatus to transmit, to a first UE, first control signaling indicating an active communication configuration between the first UE and the base station, transmit, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, and transmit, to the first UE using an antenna panel of the set of multiple antenna panels, a downlink message in accordance with the UE cooperation configuration.

Another apparatus for wireless communications at a base station is described. The apparatus may include means for transmitting, to a first UE, first control signaling indicating an active communication configuration between the first UE and the base station, means for transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, and means for transmitting, to the first UE using an antenna panel of the set of multiple antenna panels, a downlink message in accordance with the UE cooperation configuration.

A non-transitory computer-readable medium storing code for wireless communications at a base station is described. The code may include instructions executable by a processor to transmit, to a first UE, first control signaling indicating an active communication configuration between the first UE and the base station, transmit, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station, and transmit, to the first UE using an antenna panel of the set of multiple antenna panels, a downlink message in accordance with the UE cooperation configuration.

Some examples of the method, apparatuses, and non-transitory computer-readable medium described herein may further include operations, features, means, or instructions for transmitting, to the first UE, a grant scheduling the downlink message, where the grant indicates an ID of the first UE or the ID of the second UE and transmitting the downlink message using a first antenna panel corresponding to the first UE or a second antenna panel corresponding to the second UE in accordance with the grant.

In some examples of the method, apparatuses, and non-transitory computer-readable medium described herein, transmitting the grant may include operations, features, means, or instructions for transmitting, to the first UE, DCI including a CIF set to a first value corresponding to the ID of the first UE or a second value corresponding to the ID of the second UE and transmitting the downlink message using the first antenna panel or the second antenna panel in accordance with the CIF.

In some examples of the method, apparatuses, and non-transitory computer-readable medium described herein, transmitting the grant may include operations, features, means, or instructions for transmitting DCI including CRC information scrambled by a first C-RNTI corresponding to the ID of the first UE or scrambled by a second C-RNTI corresponding to the ID of the second UE and transmitting the downlink message using the first antenna panel or the second antenna panel in accordance with the first C-RNTI or the second C-RNTI.

Some examples of the method, apparatuses, and non-transitory computer-readable medium described herein may further include operations, features, means, or instructions for transmitting the downlink message using the first antenna panel corresponding to the first UE and receiving, from the first UE, a feedback message in response to the downlink message.

Some examples of the method, apparatuses, and non-transitory computer-readable medium described herein may further include operations, features, means, or instructions for transmitting the downlink message using the second antenna panel corresponding to the second UE and receiving, from the second UE, a feedback message in response to the downlink message.

In some examples of the method, apparatuses, and non-transitory computer-readable medium described herein, the active communication configuration between the first UE and the base station includes an RRC configuration between the first UE and the base station, the active communication configuration between the second UE and the base station includes an RRC configuration between the second UE and the base station, the second control signaling includes an RRC reconfiguration message indicating the ID of the second UE and the portion of the active communication configuration between the second UE and the base station, and the portion of the active communication configuration between the second UE and the base station includes a DCI format corresponding to the second UE, a type of the RRC configuration between the second UE and the base station, or both.

In some examples of the method, apparatuses, and non-transitory computer-readable medium described herein, the ID of the second UE includes one of a C-RNTI, an antenna panel ID, a serving cell index, a CORESET ID, or a component carrier ID.

In some examples of the method, apparatuses, and non-transitory computer-readable medium described herein, the type of the RRC configuration between the second UE and the base station includes a downlink shared channel configuration, a downlink control channel configuration, an uplink shared channel configuration, an uplink control channel configuration, or a combination thereof.

Some examples of the method, apparatuses, and non-transitory computer-readable medium described herein may further include operations, features, means, or instructions for transmitting activation signaling indicating an activation of UE cooperation between the first UE and the second UE in accordance with the UE cooperation configuration, where the activation signaling includes a first field indicating the activation of the UE cooperation, a second field indicating an ID of the first UE and the ID of the second UE, a third field indicating a type of the UE cooperation to be activated, or a combination thereof.

Some examples of the method, apparatuses, and non-transitory computer-readable medium described herein may further include operations, features, means, or instructions for transmitting deactivation signaling indicating a deactivation of the UE cooperation between the first UE and the second UE, where the deactivation signaling includes the first field indicating the deactivation of the UE cooperation, the second field indicating the ID of the first UE and the ID of the second UE, the third field indicating the type of the UE cooperation to be deactivated, or a combination thereof.

In some examples of the method, apparatuses, and non-transitory computer-readable medium described herein, the type of the UE cooperation corresponds to cooperation for uplink communications, downlink communications, communications via an uplink control channel, communications via a downlink control channel, or a combination thereof.

Some examples of the method, apparatuses, and non-transitory computer-readable medium described herein may further include operations, features, means, or instructions for transmitting the activation signaling via a first MAC-CE and transmitting the deactivation signaling via a second MAC-CE.

Some examples of the method, apparatuses, and non-transitory computer-readable medium described herein may further include operations, features, means, or instructions for receiving, from the first UE, a request for UE cooperation with the second UE in accordance with a UE cooperation negotiation procedure performed between the first UE and the second UE and transmitting the second control signaling to the first UE in response to the request for UE cooperation.

### BRIEF DESCRIPTION OF THE DRAWINGS

FIG. 1 illustrates an example of a wireless communications system that supports configuration for user equipment (UE) cooperation in accordance with aspects of the present disclosure.

FIG. 2 illustrates an example of a wireless communications system that supports configuration for UE cooperation in accordance with aspects of the present disclosure.

FIG. 3 illustrates an example of a UE cooperation timeline that supports configuration for UE cooperation in accordance with aspects of the present disclosure.

FIG. 4 illustrates an example of a process flow that supports configuration for UE cooperation in accordance with aspects of the present disclosure.

FIGS. 5 and 6 show block diagrams of devices that support configuration for UE t cooperation in accordance with aspects of the present disclosure.

FIG. 7 shows a block diagram of a communications manager that supports configuration for UE cooperation in accordance with aspects of the present disclosure.

FIG. 8 shows a diagram of a system including a device that supports configuration for UE cooperation in accordance with aspects of the present disclosure.

FIGS. 9 and 10 show block diagrams of devices that support configuration for UE cooperation in accordance with aspects of the present disclosure.

FIG. 11 shows a block diagram of a communications manager that supports configuration for UE cooperation in accordance with aspects of the present disclosure.

FIG. 12 shows a diagram of a system including a device that supports configuration for UE cooperation in accordance with aspects of the present disclosure.

FIGS. 13 through 15 show flowcharts illustrating methods that support configuration for UE cooperation in accordance with aspects of the present disclosure.

### DETAILED DESCRIPTION

In some wireless communications systems, a network node such as a base station or a transmission and reception point (TRP) or the like may communicate with multiple antenna panels on a user equipment (UE) as a single entity. For example, the network node may send and receive messages from the individual antenna panels of the UE, but may recognize that the individual panels are configured as a single entity from the perspective of the network. Such a configuration may be referred to as a localized panel configuration. In some examples, being configured as a single entity from the perspective of the network may refer to being configured with a common communication configuration such as being configured as a single radio resource control (RRC) entity.

In some examples, the multiple antenna panels may be associated with a group of two or more UEs. In such examples, even though the antenna panels are distributed across multiple separate UEs, the network node may consider the multiple distributed antenna panels as a single entity (e.g., a single radio resource control (RRC) entity). Such a configuration may be referred to as a distributed panels configuration. In such scenarios, one or more network nodes (e.g., TRPs or base stations or the like) may send and receive messages from antenna panels of different UEs, but from the perspective of the network, these messages are configured as being communicated with a single configured entity (e.g., a single RRC entity). In such a configuration, the network may not be aware of which UE a communication is being received from or transmitted to, but instead may recognize communications as coming from or being sent to a single entity.

The two or more UEs may communicate via sidelink communication links to transfer the information received from the base station between one another. For example, a network node may transmit a message to an antenna panel of a first UE although the message is intended for a second UE (e.g., a target UE). The process of communicating the information between the UEs to ensure the correct UE (e.g., a target UE) receives the information may be referred to as UE cooperation. For example, the first UE may recognize that the received message is intended for the second UE and may transmit or relay the message to the second UE. In some examples, because the multiple antenna panels from the separate UEs are configured as a single entity from the perspective of the network, the network may be unaware of or may not directly configure or control the process of how the UEs communicate with each other to relay the information to a target UE.

To enable UE cooperation between a group of two or more UEs, at least one of the cooperating UEs (e.g., the target UE) may receive control signaling indicating a UE cooperation configuration. The UE cooperation configuration may indicate, to the target UE, a configuration for communicating messages, as a single entity, between the base station and a set of antenna panels corresponding to the group of cooperative UEs. Each of the cooperating UEs may operate in an active communication state. That is, prior to transmitting the UE cooperation configuration, the base station may transmit control signaling to each cooperative UE indicating an active communication configuration between the cooperative UE and the base station. The active communication configuration may enable communication between the UE and the base station on an uplink, a downlink, or both. The base station may subsequently transmit the UE cooperation configuration to the target UE to indicate an identifier (ID) and at least a portion of the active communication configuration for each UE of the group of cooperative UEs. The UE cooperation configuration may provide for the target UE to initiate UE cooperation between the group of cooperative UEs to effectively and efficiently communicate with the base station as a single entity using multiple antenna panels associated with the group of cooperative UEs.

In some examples, the base station may transmit activation or deactivation signaling (e.g., via a medium access control control element (MAC-CE)) to the target UE to activate or deactivate the UE cooperation. The group of UEs may communicate with the base station as the single entity according to the UE cooperation configuration in response to the activation signaling. In response to the deactivation signaling, the group of UEs may refrain from performing UE cooperation. If the group of UEs are configured to support UE cooperation, the base station may transmit a grant (e.g., downlink control information (DCI)) to the target UE to schedule each downlink message intended for the group of UEs. The grant may indicate an ID of the target UE or an ID of one of the other UEs of the group of UEs. The target UE may identify, from the set of antenna panels corresponding to the group of UEs, an antenna panel for reception of the downlink message based on the grant and the indicated ID.

Aspects of the disclosure are initially described in the context of wireless communications systems. Additional aspects are described in the with reference to UE cooperation timelines and process flows. Aspects of the disclosure are further illustrated by and described with reference to apparatus diagrams, system diagrams, and flowcharts that relate to configuration for UE cooperation.

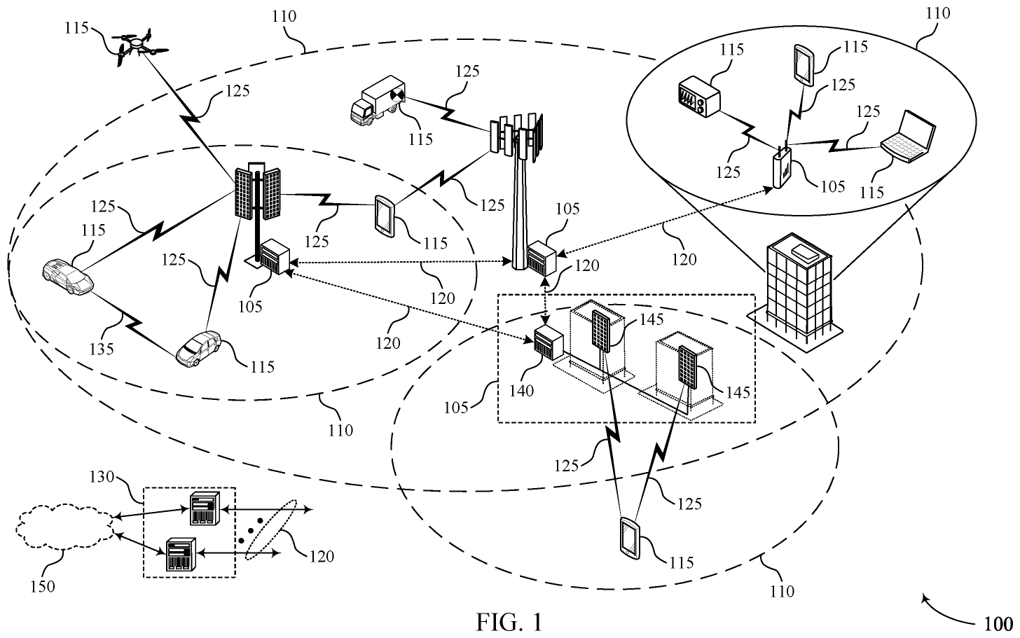

FIG. 1 illustrates an example of a wireless communications system 100 that supports configuration for UE cooperation in accordance with aspects of the present disclosure. The wireless communications system 100 may include one or more base stations 105, one or more UEs 115, and a core network 130. In some examples, the wireless communications system 100 may be a Long Term Evolution (LTE) network, an LTE-Advanced (LTE-A) network, an LTE-A Pro network, or a New Radio (NR) network. In some examples, the wireless communications system 100 may support enhanced broadband communications, ultra-reliable (e.g., mission critical) communications, low latency communications, communications with low-cost and low-complexity devices, or any combination thereof.

The base stations 105 may be dispersed throughout a geographic area to form the wireless communications system 100 and may be devices in different forms or having different capabilities. The base stations 105 and the UEs 115 may wirelessly communicate via one or more communication links 125. Each base station 105 may provide a coverage area 110 over which the UEs 115 and the base station 105 may establish one or more communication links 125. The coverage area 110 may be an example of a geographic area over which a base station 105 and a UE 115 may support the communication of signals according to one or more radio access technologies.

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115, the base stations 105, or network equipment (e.g., core network nodes, relay devices, integrated access and backhaul (IAB) nodes, or other network equipment), as shown in FIG. 1.

The base stations 105 may communicate with the core network 130, or with one another, or both. For example, the base stations 105 may interface with the core network 130 through one or more backhaul links 120 (e.g., via an S1, N2, N3, or other interface). The base stations 105 may communicate with one another over the backhaul links 120 (e.g., via an X2, Xn, or other interface) either directly (e.g., directly between base stations 105), or indirectly (e.g., via core network 130), or both. In some examples, the backhaul links 120 may be or include one or more wireless links.

One or more of the base stations 105 described herein may include or may be referred to by a person having ordinary skill in the art as a base transceiver station, a radio base station, an access point, a radio transceiver, a NodeB, an eNodeB (eNB), a next-generation NodeB or a giga-NodeB (either of which may be referred to as a gNB), a Home NodeB, a Home eNodeB, or other suitable terminology.

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the base stations 105 and the network equipment including macro eNBs or gNBs, small cell eNBs or gNBs, or relay base stations, among other examples, as shown in FIG. 1.

The UEs 115 and the base stations 105 may wirelessly communicate with one another via one or more communication links 125 over one or more carriers. The term “carrier” may refer to a set of radio frequency spectrum resources having a defined physical layer structure for supporting the communication links 125. For example, a carrier used for a communication link 125 may include a portion of a radio frequency spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers.

In some examples (e.g., in a carrier aggregation configuration), a carrier may also have acquisition signaling or control signaling that coordinates operations for other carriers. A carrier may be associated with a frequency channel (e.g., an evolved universal mobile telecommunication system terrestrial radio access (E-UTRA) absolute radio frequency channel number (EARFCN)) and may be positioned according to a channel raster for discovery by the UEs 115. A carrier may be operated in a standalone mode where initial acquisition and connection may be conducted by the UEs 115 via the carrier, or the carrier may be operated in a non-standalone mode where a connection is anchored using a different carrier (e.g., of the same or a different radio access technology).

The communication links 125 shown in the wireless communications system 100 may include uplink transmissions from a UE 115 to a base station 105, or downlink transmissions from a base station 105 to a UE 115. Carriers may carry downlink or uplink communications (e.g., in an FDD mode) or may be configured to carry downlink and uplink communications (e.g., in a TDD mode).

A carrier may be associated with a particular bandwidth of the radio frequency spectrum, and in some examples the carrier bandwidth may be referred to as a “system bandwidth” of the carrier or the wireless communications system 100. For example, the carrier bandwidth may be one of a number of determined bandwidths for carriers of a particular radio access technology (e.g., 1.4, 3, 5, 10, 15, 20, 40, or 80 megahertz (MHz)). Devices of the wireless communications system 100 (e.g., the base stations 105, the UEs 115, or both) may have hardware configurations that support communications over a particular carrier bandwidth or may be configurable to support communications over one of a set of carrier bandwidths. In some examples, the wireless communications system 100 may include base stations 105 or UEs 115 that support simultaneous communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may consist of one symbol period (e.g., a duration of one modulation symbol) and one subcarrier, where the symbol period and subcarrier spacing are inversely related. The number of bits carried by each resource element may depend on the modulation scheme (e.g., the order of the modulation scheme, the coding rate of the modulation scheme, or both). Thus, the more resource elements that a UE 115 receives and the higher the order of the modulation scheme, the higher the data rate may be for the UE 115. A wireless communications resource may refer to a combination of a radio frequency spectrum resource, a time resource, and a spatial resource (e.g., spatial layers or beams), and the use of multiple spatial layers may further increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the base stations 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a number of slots. Alternatively, each frame may include a variable number of slots, and the number of slots may depend on subcarrier spacing. Each slot may include a number of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., the number of symbol periods in a TTI) may be variable. Additionally or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a number of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to a number of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

Each base station 105 may provide communication coverage via one or more cells, for example a macro cell, a small cell, a hot spot, or other types of cells, or any combination thereof. The term “cell” may refer to a logical communication entity used for communication with a base station 105 (e.g., over a carrier) and may be associated with an identifier for distinguishing neighboring cells (e.g., a physical cell identifier (PCID), a virtual cell identifier (VCID), or others). In some examples, a cell may also refer to a geographic coverage area 110 or a portion of a geographic coverage area 110 (e.g., a sector) over which the logical communication entity operates. Such cells may range from smaller areas (e.g., a structure, a subset of structure) to larger areas depending on various factors such as the capabilities of the base station 105. For example, a cell may be or include a building, a subset of a building, or exterior spaces between or overlapping with geographic coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered base station 105, as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A base station 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a base station 105 may be movable and therefore provide communication coverage for a moving geographic coverage area 110. In some examples, different geographic coverage areas 110 associated with different technologies may overlap, but the different geographic coverage areas 110 may be supported by the same base station 105. In other examples, the overlapping geographic coverage areas 110 associated with different technologies may be supported by different base stations 105. The wireless communications system 100 may include, for example, a heterogeneous network in which different types of the base stations 105 provide coverage for various geographic coverage areas 110 using the same or different radio access technologies.

The wireless communications system 100 may support synchronous or asynchronous operation. For synchronous operation, the base stations 105 may have similar frame timings, and transmissions from different base stations 105 may be approximately aligned in time. For asynchronous operation, the base stations 105 may have different frame timings, and transmissions from different base stations 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a base station 105 without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception simultaneously). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC) or mission critical communications. The UEs 115 may be designed to support ultra-reliable, low-latency, or critical functions (e.g., mission critical functions). Ultra-reliable communications may include private communication or group communication and may be supported by one or more mission critical services such as mission critical push-to-talk (MCPTT), mission critical video (MCVideo), or mission critical data (MCData). Support for mission critical functions may include prioritization of services, and mission critical services may be used for public safety or general commercial applications. The terms ultra-reliable, low-latency, mission critical, and ultra-reliable low-latency may be used interchangeably herein.

In some examples, a UE 115 may also be able to communicate directly with other UEs 115 over a device-to-device (D2D) communication link 135 (e.g., using a peer-to-peer (P2P) or D2D protocol). One or more UEs 115 utilizing D2D communications may be within the geographic coverage area 110 of a base station 105. Other UEs 115 in such a group may be outside the geographic coverage area 110 of a base station 105 or be otherwise unable to receive transmissions from a base station 105. In some examples, groups of the UEs 115 communicating via D2D communications may utilize a one-to-many (1:M) system in which each UE 115 transmits to every other UE 115 in the group. In some examples, a base station 105 facilitates the scheduling of resources for D2D communications. In other cases, D2D communications are carried out between the UEs 115 without the involvement of a base station 105.

In some systems, the D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., base stations 105) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the base stations 105 associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

Some of the network devices, such as a base station 105, may include subcomponents such as an access network entity 140, which may be an example of an access node controller (ANC). Each access network entity 140 may communicate with the UEs 115 through one or more other access network transmission entities 145, which may be referred to as radio heads, smart radio heads, or transmission/reception points (TRPs). Each access network transmission entity 145 may include one or more antenna panels. In some configurations, various functions of each access network entity 140 or base station 105 may be distributed across various network devices (e.g., radio heads and ANCs) or consolidated into a single network device (e.g., a base station 105).

The wireless communications system 100 may operate using one or more frequency bands, typically in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the base stations 105, and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed radio frequency spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. When operating in unlicensed radio frequency spectrum bands, devices such as the base stations 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A base station 105 or a UE 115 may be equipped with multiple antennas, which may be used to employ techniques such as transmit diversity, receive diversity, multiple-input multiple-output (MIMO) communications, or beamforming. The antennas of a base station 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a base station 105 may be located in diverse geographic locations. A base station 105 may have an antenna array with a number of rows and columns of antenna ports that the base station 105 may use to support beamforming of communications with a UE 115. Likewise, a UE 115 may have one or more antenna arrays that may support various MIMO or beamforming operations. Additionally or alternatively, an antenna panel may support radio frequency beamforming for a signal transmitted via an antenna port.

The base stations 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry bits associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a base station 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A base station 105 or a UE 115 may use beam sweeping techniques as part of beam forming operations. For example, a base station 105 may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a base station 105 multiple times in different directions. For example, the base station 105 may transmit a signal according to different beamforming weight sets associated with different directions of transmission. Transmissions in different beam directions may be used to identify (e.g., by a transmitting device, such as a base station 105, or by a receiving device, such as a UE 115) a beam direction for later transmission or reception by the base station 105.

Some signals, such as data signals associated with a particular receiving device, may be transmitted by a base station 105 in a single beam direction (e.g., a direction associated with the receiving device, such as a UE 115). In some examples, the beam direction associated with transmissions along a single beam direction may be determined based on a signal that was transmitted in one or more beam directions. For example, a UE 115 may receive one or more of the signals transmitted by the base station 105 in different directions and may report to the base station 105 an indication of the signal that the UE 115 received with a highest signal quality or an otherwise acceptable signal quality.

In some examples, transmissions by a device (e.g., by a base station 105 or a UE 115) may be performed using multiple beam directions, and the device may use a combination of digital precoding or radio frequency beamforming to generate a combined beam for transmission (e.g., from a base station 105 to a UE 115). The UE 115 may report feedback that indicates precoding weights for one or more beam directions, and the feedback may correspond to a configured number of beams across a system bandwidth or one or more sub-bands. The base station 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 105, a UE 115 may employ similar techniques for transmitting signals multiple times in different directions (e.g., for identifying a beam direction for subsequent transmission or reception by the UE 115) or for transmitting a signal in a single direction (e.g., for transmitting data to a receiving device).

A receiving device (e.g., a UE 115) may try multiple receive configurations (e.g., directional listening) when receiving various signals from the base station 105, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or Packet Data Convergence Protocol (PDCP) layer may be IP-based. A Radio Link Control (RLC) layer may perform packet segmentation and reassembly to communicate over logical channels. A Medium Access Control (MAC) layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a base station 105 or a core network 130 supporting radio bearers for user plane data. At the physical layer, transport channels may be mapped to physical channels.

The UEs 115 and the base stations 105 may support retransmissions of data to increase the likelihood that data is received successfully. Hybrid automatic repeat request (HARQ) feedback is one technique for increasing the likelihood that data is received correctly over a communication link 125. HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In other cases, the device may provide HARQ feedback in a subsequent slot, or according to some other time interval.

In some examples, at least a first UE 115 and a second UE 115 may perform UE cooperation to communicate with a base station 105 as a single entity. The base station 105 may transmit, to the first UE 115, an active communication configuration between the first UE 115 and the base station 105. The active communication configuration may establish control information and other parameters for communications between the UE 115 and the base station 105. In some examples, the active communication configuration may be an active RRC configuration. The base station 105 may transmit, to the second UE 115, an active communication configuration between the second UE 115 and the base station 105. The first UE 115 may subsequently receive, from the base station 105, a UE cooperation configuration that configures cooperation between the first UE 115 and the second UE 115. The UE cooperation configuration may configure the UEs 115 to communicate messages between the base station 105 and a set of antenna panels corresponding to at least the first UE 115 and the second UE 115. The set of antenna panels may be configured as a single entity, from the perspective of the base station 105, according to the UE cooperation configuration. In some examples, the UE cooperation configuration may include an ID of the second UE 115 and at least a portion of the active communication configuration between the second UE 115 and the base station 105. While performing UE cooperation, the first UE 115 may identify, from the set of antenna panels corresponding to at least the first UE 115 and the second UE 115, an antenna panel for reception of a downlink message from the base station 105 based on the UE cooperation configuration. The first UE 115 may identify the antenna panel based on a grant received from the base station 105, the ID of the second UE 115, an ID of the first UE 115, or any combination thereof. The first UE 115 or the second UE 115 may receive the downlink message via the identified antenna panel of the set of antenna panels, and the first UE 115 may transmit a message (e.g., a feedback message) to the base station 105, to the second UE 115, or both in response to the downlink message.

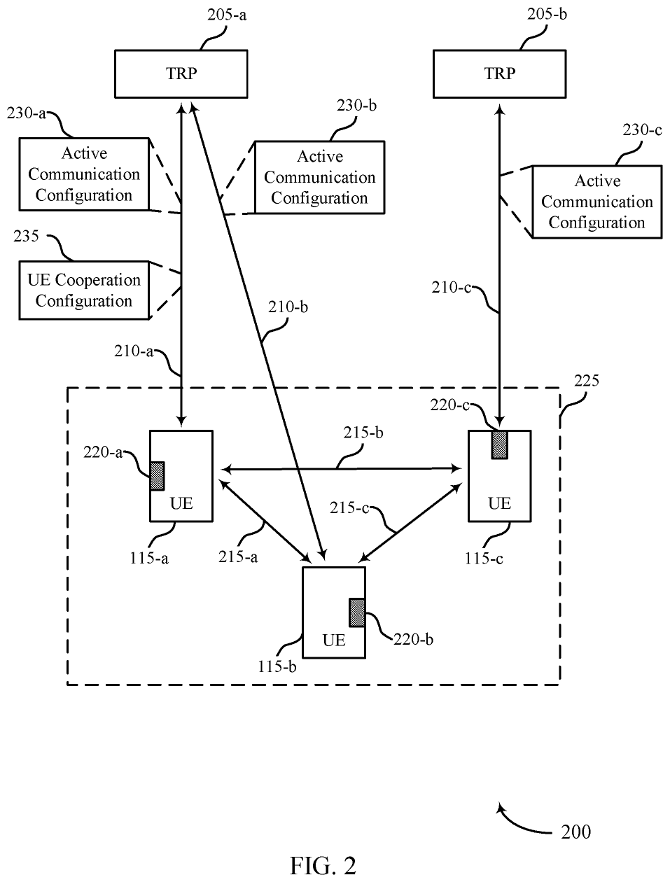

FIG. 2 illustrates an example of a wireless communications system 200 that supports configuration for UE cooperation in accordance with aspects of the present disclosure. In some examples, the wireless communications system 200 may implement aspects of the wireless communications system 100. The wireless communications system 200 may include network nodes such as a TRP 205-a, a TRP 205-b, and a group of UEs 115, including a UE 115-a, a UE 115-b, and a UE 115-c. The TRPs 205 and the group of UEs 115 may be examples of corresponding devices as described with reference to FIG. 1. For example, the TRPs 205 may be examples of a base station 105 or subcomponents of a base station 105 as described with reference to FIG. 1, and the UEs 115 may be examples of a UE 115 as described with reference to FIG. 1. In some examples, a TRP 205 may transmit a UE cooperation configuration 235 to at least one UE 115 of the group of UEs 115 to indicate a configuration for the group of UEs 115 to communicate with the TRP 205 as a single entity (e.g., a distributed unit 225).

In the example of the wireless communications system 200, the network may communicate with the UEs 115 through one or more access network transmission entities, which may be referred to as radio heads, smart radio heads, or the TRPs 205. Each access network transmission entity may include one or more antenna panels. In some configurations, various functions of each access network transmission entity may be distributed across various network devices (e.g., radio heads and ANCs) or consolidated into a single network device (e.g., a base station 105). The TRPs 205-a and 205-b may thereby be associated with one or more base stations 105. The UEs 115-a, 115-b, and 115-c may communicate with the network via the TRPs 205-a and 205-b and the corresponding communication links 210-a, 210-b, and 210-c (e.g., Uu links).

Each of the UEs 115-a, 115-b, and 115-c may receive an active communication configuration 230 (e.g., the active communication configurations 230-a, 230-b, and 230-c, respectively) from the network via the TRPs 205-a and 205-b. Each active communication configuration 230 may establish a communication link 210 between the UE 115 and the respective TRP 205. The UEs 115 may communicate with the TRPs 205 while operating in an active status according to the active communication configurations 230. For example, the active communication configuration 230-c may configure the UE 115-c to communicate with the TRP 205-b via the communication link 210-c (e.g., an uplink, a downlink, or both). In some examples, the active communication configuration 230 may include an RRC configuration, and the active status of a UE 115 may be an example of a RRC active status. For example, the active communication configuration 230-c may be transmitted to the UE 115-c via an RRC configuration message to initiate an RRC procedure and enable communication via the communication link 210-c.

The active communication configurations 230 may each include one or more parameters for communications via the configured communication link 210. For example, the active communication configurations 230 may assign each UE 115 with an ID for communicating with the network. The ID may be a control radio network temporary identifier (C-RNTI), an antenna panel ID, a serving cell index, a component carrier ID, or a CORESET ID. The active communication configuration 230 for each UE 115 may indicate a DCI format corresponding to communications between the UE 115 and a respective TRP 205, a type of the communications between the UE 115 and the TRP 205 according to the configuration, one or more other parameters associated with the communications between the UE 115 and the TRP 205, or any combination thereof. In some examples, the type of communications indicated via the active communication configuration 230 may be a downlink shared channel configuration, a downlink control channel configuration, an uplink shared channel configuration, an uplink control channel configuration, or any combination thereof. For example, the active communication configuration 230-b may configure an uplink communication link 210-b for uplink transmissions (e.g., via a physical uplink shared channel (PUSCH), a physical uplink control channel (PUCCH), or both) between the UE 115-b and the TRP 205-a (e.g., the communication link 210-b may be configured to support uplink, but not downlink, communications).

Each of the UEs 115-a, 115-b, and 115-c may include one or more physical antenna panels 220 (e.g., TRPs at the UE 115) for communication by the UE 115. Each antenna panel 220 may include a number of antenna modules or digital antenna ports. In some cases, the antenna panels 220 may be co-located on a single UE 115. In one example, the UE 115-a may include the antenna panel 220-a and a second antenna panel 220 (not pictured in FIG. 2). The UE 115-a may communicate with the TRP 205-a via the communication link 210-a as a single entity. That is, the two antenna panels 220 co-located on the UE 115-a may be considered as a single entity (e.g., a single RRC entity) by the network, and the UE 115-a may receive a single active communication configuration 230 for communications between the UE 115-a and the TRP 205-a using one or both of the antenna panels 220.

Additionally or alternatively, the antenna panels 220 may be distributed across multiple UEs 115, and the network may consider the distributed antenna panels 220 as a single entity for communication. For example, the antenna panels 220-a, 220-b, and 220-c may correspond to the UEs 115-a, 115-b, and 115-c, respectively, and the UEs 115-a, 115-b, and 115-c may perform UE cooperation to form a distributed unit 225, which may also be referred to as a single entity, a virtual UE, or a disaggregated UE. UE cooperation may refer to the UEs 115-a, 115-b, and 115-c communicating data and control information between one another via sidelink communication links 215 (e.g., the sidelink communication links 215-a, 215-b, and 215-c). In some examples, one of the UEs 115 may be referred to as a target UE 115, and the remaining cooperative UEs 115 of the group of UEs 115 may cooperate to transfer received data and control information to the target UE 115. For example, the UE 115-a may be a target UE 115-a. If the cooperative UEs 115-b and 115-c receive (e.g., via the antenna panels 220-b or 220-c) downlink data or control information, the cooperative UEs 115-b and 115-c may communicate with the target UE 115-a via the sidelink communication links 215-a and 215-b, or with each other via the sidelink communication link 215-c, to forward the downlink messages to the target UE 115-a.

The network may consider the distributed unit 225 including the antenna panels 220-a, 220-b, and 220-c corresponding to the UEs 115-a, 115-b, and 115-c as a single entity for communication (e.g., a single RRC entity). The network may identify and define the distributed unit 225 according to one or more antenna panels 220, UEs 115, resource configurations for the distributed unit 225, or any combination thereof. For example, the network may define the distributed unit 225 according to a UE ID (e.g., an ID of one of the cooperative UEs 115), and the network may consider the distributed unit 225 to be a single unit that includes three antenna panels 220 and corresponds to the UE ID. In another example, the network may define the distributed unit 225 according to a panel ID (e.g., an ID of one of the distributed antenna panels 220). Additionally or alternatively, the network may define the distributed unit 225 according to a configured resource ID (e.g., an ID of a CORESET configured for the distributed unit 225, a set of PUCCH resources configured for the distributed unit 225, or the like). The network may establish the communication links 210-a, 210-b, and 210-c with the antenna panels 220-a, 220-b, and 220-c, respectively, of the distributed unit 225, and the network may communicate with the antenna panels 220-a, 220-b, and 220-c as a single entity in accordance with the selected ID.

Each of the UEs 115-a, 115-b, and 115-c may receive the active communication configurations 230-a, 230-b, and 230-c, respectively, to establish respective communication links 210 with the network. In some cases, however, the UEs 115 may not receive signaling indicating a configuration for cooperating as the distributed unit 225. For example, each UE 115 may not be aware of the active communication configuration 230 for the other UEs 115. Additionally or alternatively, the UEs 115 may not know which other UEs 115 are part of the distributed unit 225. In such cases, UE cooperation may not be enabled between the UEs 115. If the UE 115-a does not receive an indication that the UEs 115-b and 115-c are part of the distributed unit 225 and an indication of at least a portion of the active communication configurations 230-b and 230-c for the UEs 115-b and 115-c, respectively, the UE 115-a may not know to cooperate with the UEs 115-b and 115-c as a single entity for communications with the network. For example, the 115-a may not know the assigned IDs for communications to or from the UEs 115-b and 115-c. As such, it may be beneficial for the base station 105 to transmit signaling to the UEs 115 to enable UE cooperation between two or more UEs 115 operating in an active communication state.

To enable UE cooperation between a group of two or more active UEs 115, at least one of the cooperating UEs 115 may receive control signaling indicating a UE cooperation configuration 235. For example, the UE 115-a (e.g., a target UE 115-a) may receive the UE cooperation configuration 235 from the network via the TRP 205-a and the communication link 210-a. The UE cooperation configuration 235 may indicate a configuration for the UE 115-a, the UE 115-b, and the UE 115-c to communicate, as a single entity (e.g., the distributed unit 225), with the network using the antenna panels 220-a, 220-b, and 220-c. In some examples, the UE cooperation configuration 235 may be an example of an RRC reconfiguration message. For example, the active communication configuration 230 may include an RRC configuration message, and the UE cooperation configuration 235 may include an RRC reconfiguration message.

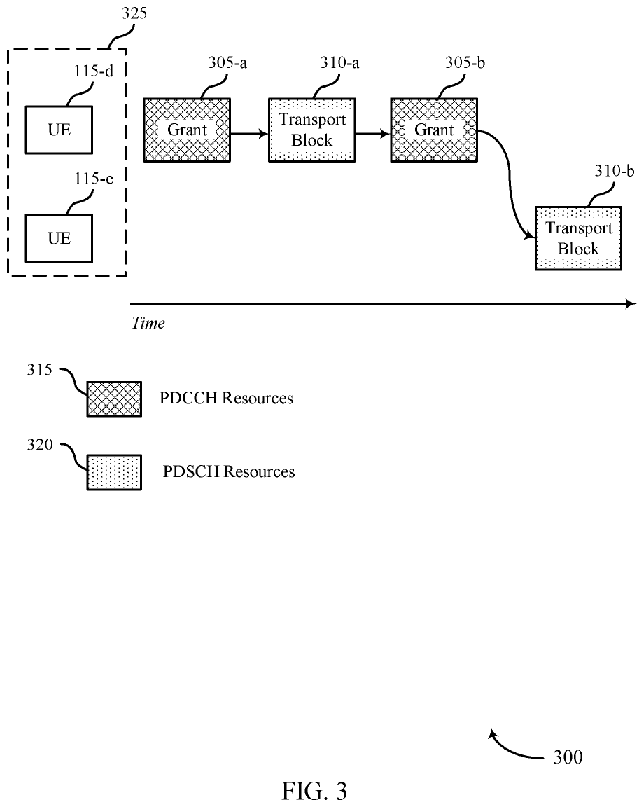

The UE cooperation configuration 235 may indicate, to the UE 115-a, the IDs of the UEs 115-b and 115-c, and at least a portion of each of the active communication configurations 230-b and 230-c for the UEs 115-b and 115-c, respectively. As such, the UE 115-a may know the IDs of the UEs 115-b and 115-c, and one or more parameters configured for communications between each of the UEs 115-b and 115-c and the network. The parameters may include a configured DCI format type, a type of communications enabled by the active communication configuration 230, some other parameters, or any combination thereof. The UE 115-a may receive DCI intended for the UE 115-b or the UE 115-c based on the indicated parameters and the UE IDs. Accordingly, messages transmitted to any one of the UEs 115-a, 115-b, and 115-c may be received by the intended UE 115 or any of the other UEs 115 in the distributed unit 225 based on the UE cooperation configuration 235. Details of the reception of downlink data and control information by the cooperative UEs 115 may be described in further detail elsewhere herein, including with reference to FIG. 3.

In some examples, the TRP 205-a may transmit the UE cooperation configuration 235 to the UE 115-a based on signaling from the network, and the UE 115-a may identify the UEs 115-b and 115-c and form the distributed unit 225 based on the UE cooperation configuration 235. Additionally or alternatively, the TRP 205-a may transmit the UE cooperation configuration 235 in response to a request for UE cooperation. For example, two or more of the UEs 115-a, 115-b, 115-c may perform a UE cooperation negotiation procedure and determine to engage in UE cooperation. In such cases, the target UE 115, for example, the UE 115-a, may transmit a request for UE cooperation to the TRP 205-a in accordance with the UE cooperation negotiation procedure. The UE 115-a may receive the UE cooperation configuration 235 in response to the request. The UE 115-a may perform the UE cooperation negotiation procedure and transmit the request for UE cooperation before or after receiving the active communication configuration 230-a. If the UE 115-a transmits the request for UE cooperation before receiving the active communication configuration 230-a, the UE 115-a may transmit the request via a UE capability report.

In some examples, the UE 115-a may perform UE cooperation in response to the UE cooperation configuration 235. Additionally or alternatively, the UE 115-a may receive activation signaling after receipt of the UE cooperation configuration 235. The activation signaling may activate the UE cooperation and indicate one or more parameters associated with the UE cooperation to be activated. The UE 115-a may form the distributed unit 225 in response to the activation signaling, and the distributed unit 225 may communicate with the TRPs 205-a and 205-b according to the indicated parameters. For example, the UE 115-a may communicate with the UEs 115-b and 115-c via the sidelink communication links 215 (e.g., PC5 links, or the like) to communicate data and control information with the network as a single entity. The UE 115-a may subsequently receive deactivation signaling deactivating the UE cooperation. The deactivation signaling may indicate the parameters, or other parameters, associated with the UE cooperation to be deactivated. The UE 115-a may communicate with the network as a single entity according to the active communication configuration 230-a in response to the deactivation signaling (e.g., the UE 115-a may not cooperate with the UEs 115-b and 115-c).

The parameters indicated via the activation signaling, the deactivation signaling, or both, may include an indication of the activation or deactivation of the UE cooperation, an ID of each UE 115 to be activated or deactivated in cooperation, a type of UE cooperation to be activated or deactivated, or any combination thereof. In some aspects, the type of UE cooperation to be activated or deactivated may correspond to cooperation for uplink communications (e.g., via a PUSCH), cooperation for downlink communications (e.g., via a physical downlink shared channel (PDSCH)), cooperation for communications via an uplink control channel (e.g., via a PUCCH), cooperation for communications via a downlink control channel (e.g., via a physical downlink control channel (PDCCH)), or any combination thereof. In some examples, the activation signaling may be transmitted via a first MAC-CE and the deactivation signaling may be transmitted via a second MAC-CE, and the first and second MAC-CEs may include respective field(s) for conveying each parameter. The UE 115-a may activate or deactivate the UE cooperation after a time offset from a confirmation of the first or second MAC-CE, respectively.

A UE 115 as described herein may thereby receive a UE cooperation configuration 235 enabling cooperation between the UE 115 and one or more other UEs 115 to form a distributed unit 225. The UEs 115 may communicate with the network as the distributed unit 225 using one or more antenna panels 220 distributed across the UEs 115 in accordance with the UE cooperation configuration. Additional details directed to the cooperation between the UEs 115 is described in further detail elsewhere herein, including with reference to FIG. 3.

FIG. 3 illustrates an example of a UE cooperation timeline 300 that supports configuration for UE cooperation in accordance with aspects of the present disclosure. In some examples, the UE cooperation timeline 300 may represent a timeline for reception of downlink messages and control information at a UE 115-d, a UE 115-e, or both. The UEs 115-d and 115-e may be examples of a UE 115 as described with reference to FIGS. 1 and 2. The UEs 115-d and 115-e may be configured to cooperate with each other as a distributed unit 325, which may be an example of a distributed unit 225 as described with reference to FIG. 2. In some examples, the UE 115-d (e.g., a target UE 115-d) may receive one or more grants 305 scheduling a downlink message intended for the distributed unit 325.

As described with reference to FIG. 2, each of the UEs 115-d and 115-e may receive an active communication configuration that indicates one or more parameters for communications between the respective UE 115 and the network. The UE 115-d may additionally or alternatively receive a UE cooperation configuration that may indicate an ID of the UE 115-e and at least a portion of the active communication configuration for the UE 115-e. For example, the UE cooperation configuration may indicate an ID of the UE 115-e, a DCI format configured for the UE 115-e, a type of the active communication configuration (e.g., an RRC configuration) between the UE 115-e and the network, or any combination thereof. The UE 115-d may accordingly monitor for and receive DCI having the configured DCI format for the UE 115-e or other downlink messages intended for the UE 115-e while performing UE cooperation. That is, the UE cooperation configuration may configure the UE 115-d to be associated with the ID of the UE 115-e.

The UEs 115-d and 115-e may initiate UE cooperation according to the UE cooperation timeline 300 in response to the UE cooperation configuration, in response to activation signaling, or both, as described with reference to FIG. 2. While the UEs 115-d and 115-e operate as the distributed unit 325 according to the UE cooperation configuration, a network entity, such as a base station 105, a TRP 205, or some other device, may transmit downlink messages (e.g., transport blocks 310) to the distributed unit 325 by transmitting the messages to an antenna panel corresponding to the UE 115-d, an antenna panel corresponding to the UE 115-e, or both. The network entity may transmit a grant 305 to the target UE 115-d of the distributed unit 325 to schedule a corresponding transport block 310. Each grant 305 may indicate the ID of the UE 115-d or the UE 115-e that is intended to receive and provide feedback for the corresponding transport block 310. The grant 305 may be transmitted as control signaling via PDCCH resources 315. In some examples, the grant 305 may include DCI.

In some examples, the ID of the UE 115-d, the ID of the UE 115-e, or both may be a local ID of the respective UE 115 in UE cooperation. For example, the ID may be an antenna panel ID, a cell indicator field (CIF) ID, or some other local ID. The antenna panel ID may be an ID of an antenna panel corresponding to the respective UE 115. The CIF ID may correspond to a first serving cell configured for the UE 115-d via the active communication configuration between the UE 115-d and the base station 105 or a second serving cell configured for the UE 115-e via the active communication configuration between the UE 115-e and the base station 105. In such cases, the first serving cell may be different from the second serving cell according to a component carrier aggregation. Accordingly, the CIF ID may be used to identify and differentiate the UEs 115-d and 115-e. The UE 115-d may receive an indication of the local ID of the UE 115-e via the UE cooperation configuration.

The base station 105 may transmit the grants 305-a and 305-b via control signaling, such as DCI. The DCI may include a field to indicate the local ID of the scheduled UE 115 in UE cooperation. If the local ID is an antenna panel ID, the field may indicate the corresponding antenna panel ID. In one example of the UE cooperation timeline 300, the grant 305-a may indicate a first antenna panel ID corresponding to the UE 115-d. The UE 115-d may receive and decode the grant 305-a and determine the corresponding transport block 310-a is intended for the UE 115-d based on the first antenna panel ID. The UE 115-d may monitor for and receive the transport block 310-a via the PDSCH resources 320 using the antenna panel corresponding to the UE 115-d in response to the grant 305-a. In some aspects, the antenna panel ID may be an explicit ID. In some other aspects, the antenna panel ID may be an implicit ID, which is associated with a CORESET pool index ID, sounding reference signal (SRS) resource set ID, or close loop index ID, and the UE may implicitly determine the antenna panel ID based on the indicated associated ID.

Additionally or alternatively, the grant 305-a may indicate the local UE ID. In some examples, the grant 305-a may include a CIF field to indicate the local UE ID. A first value of the CIF field (e.g., CIF=0) may indicate the target UE 115-d is scheduled to receive the corresponding transport block 310, and a second value of the CIF field (e.g., CIF=1) may indicate the UE 115-e, or another cooperative UE 115 of the distributed unit 325 (not pictured in FIG. 3), is scheduled to receive the corresponding transport block 310. In one example of the UE cooperation timeline 300, the grant 305-b may include a CIF field set to the second value. The UE 115-d may receive and decode the grant 305-b to determine that the corresponding transport block 310-b is intended for the cooperative UE 115-e based on the CIF field. The UE 115-e may receive the transport block 310-b via the PDSCH resources 320 using an antenna panel corresponding to the UE 115-e.

In some examples, the ID of the UE 115-d, the ID of the UE 115-e, or both, may be a global ID, such as a C-RNTI. The UE 115-d may receive an indication of the C-RNTI for the UE 115-e via the UE cooperation configuration. Additionally or alternatively, the UE 115-d and the UE 115-e may exchange C-RNTIs, such that the UEs 115-d and 115-e may each monitor for DCI scrambled by both a first C-RNTI for the UE 115-d and a second C-RNTI for the UE 115-e. The base station 105 may transmit the grants 305-a and 305-b via DCI including CRC information (e.g., CRC bits) scrambled by the first C-RNTI or the second C-RNTI to indicate which UE 115 is scheduled to receive the corresponding transport block 310. In one example of the UE cooperation timeline 300, the grant 305-a may include CRC information scrambled by the first C-RNTI corresponding to the UE 115-d, and the grant 305-b may include CRC information scrambled by the second C-RNTI corresponding to the UE 115-e. The UE 115-d may receive the grant 305-a and determine that the UE 115-d is scheduled to receive the corresponding transport block 310-a at an antenna panel corresponding to the UE 115-d based on the first C-RNTI. The UE 115-d may subsequently receive the grant 305-b in accordance with the second C-RNTI (e.g., the UE 115-d may be associated with the C-RNTI of the UE 115-e). The UE 115-d may determine that the UE 115-e is scheduled to receive the corresponding transport block 310-b at an antenna panel corresponding to the UE 115-e based on the second C-RNTI.

In the example of the UE cooperation timeline 300, the UE 115-d may receive the transport block 310-a in accordance with the grant 305-a. The UE 115-d may decode the transport block 310-a and perform a HARQ procedure to transmit a HARQ feedback message to the base station 105 in response to the transport block 310-a. The transport block 310-b may be scheduled for the UE 115-e. The UE 115-e may use an antenna panel on the UE 115-e for reception of the transport block 310-b. The UE 115-e may decode the transport block 310-b and transmit a HARQ feedback message to the base station 105 in response to the transport block 310-b. In some examples, the UE 115-e may communicate the information included in the transport block 310-b with the UE 115-d (e.g., a target UE 115-d), and the UE 115-d may transmit a message (e.g., a feedback message) to the UE 115-e in response.

Accordingly, the base station 105 may transmit one or more grants 305 to schedule subsequent downlink messages intended for the distributed unit 325 and to indicate which UE 115 of the distributed unit 325 is intended to receive and provide feedback for the downlink message. A UE 115 as described herein may be configured to be associated with an ID of another UE 115 in cooperation with the UE 115. Such techniques for scheduling communications to a distributed unit 325 including two or more cooperative UEs 115 may provide for improved coordination between devices and reduced latency while performing UE cooperation.

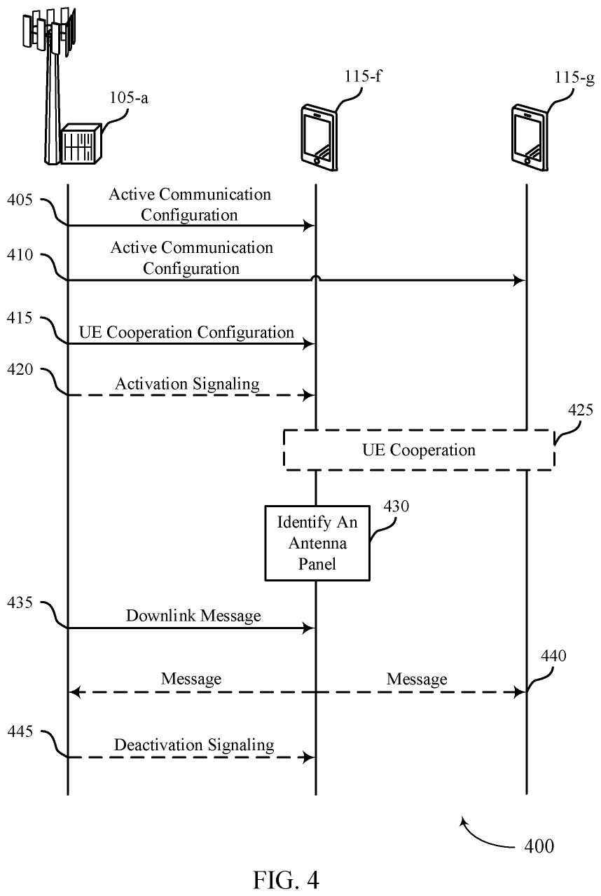

FIG. 4 illustrates an example of a process flow 400 that supports configuration for UE cooperation in accordance with aspects of the present disclosure. The process flow 400 may implement various aspects of the present disclosure described with reference to FIGS. 1-3. The process flow 400 may include a base station 105-a, a UE 115-f, and a UE 115-g, which may be examples of a base station 105 and UEs 115 as described with reference to FIGS. 1-3. In some examples, the UE 115-f may receive a UE cooperation configuration for cooperating with the UE 115-g.

In the following description of the process flow 400, the operations between the UE 115-f, the UE 115-g, and the base station 105-a may be performed in different orders or at different times. Certain operations may also be left out of the process flow 400, or other operations may be added. Although the base station 105-a, the UE 115-f, and the UE 115-g are shown performing the operations of the process flow 400, some aspects of some operations may also be performed by one or more other wireless devices.

At 405, the UE 115-f may receive control signaling from the base station 105-a indicating an active communication configuration between the UE 115-f and the base station 105-a. At 410, the UE 115-g may receive control signaling from the base station 105-a indicating an active communication configuration between the UE 115-g and the base station 105-a. In some examples, the active communication configuration between the UE 115-f and the base station 105-a, the active communication configuration between the UE 115-g and the base station 105-a, or both, may include an RRC configuration.

At 415, the UE 115-f (e.g., a target UE 115-f) may receive second control signaling from the base station 105-a indicating a UE cooperation configuration between at least the UE 115-f and the UE 115-g. The UE cooperation configuration may include a configuration for communicating messages between the base station 105-a and a set of antenna panels corresponding to at least the UE 115-f and the UE 115-g. The set of antenna panels may be configured as a single entity according to the UE cooperation configuration. The second control signaling may include an ID of the UE 115-g and at least a portion of the active communication configuration between the UE 115-g and the base station 105-a. In some examples, the second control signaling may include an RRC reconfiguration message indicating the ID of the UE 115-g and the portion of the active communication configuration between the UE 115-g and the base station 105-a.

At 420, in some examples, the UE 115-f may receive activation signaling from the base station 105-a. The activation signaling may indicate an activation of UE cooperation between the UE 115-f and the UE 115-g in accordance with the UE cooperation configuration. In some examples, the activation signaling may include a first field indicating the activation of the UE cooperation, a second field indicating an ID of the UE 115-f and the ID of the UE 115-g, a third field indicating a type of the UE cooperation to be activated, or any combination thereof.

At 425, in some examples, the UE 115-f and the UE 115-g may perform UE cooperation in accordance with the UE cooperation configuration. The UE 115-f and the UE 115-g may perform the UE cooperation in response to the UE cooperation configuration, the activation signaling, or both. In some examples, performing UE cooperation may include communicating messages between the UE 115-f and the UE 115-g, between the UE 115-f and the base station 105-a, between the UE 115-g and the base station 105-a, or any combination thereof, as described in further detail elsewhere herein, including with reference to FIG. 3.

At 430, the UE 115-f may identify, from the set of antenna panels corresponding to at least the UE 115-f and the UE 115-g, an antenna panel for reception of a downlink message from the base station 105-a based on the UE cooperation configuration. The UE 115-f may identify the antenna panel as part of performing the UE cooperation at 425. In some examples, the UE 115-f may identify the antenna panel from a first antenna panel corresponding to the UE 115-f and a second antenna panel corresponding to the UE 115-g in accordance with a grant received from the base station 105-a.

At 435, the base station 105-a may transmit the downlink message to the UE 115-f using the antenna panel of the set of antenna panels. For example, the base station may transmit the downlink message to the first antenna panel corresponding to the UE 115-f or the second antenna panel corresponding to the UE 115-g.

At 440, the UE 115-f may transmit a message to the base station 105-a, the UE 115-g, or both in response to the downlink message and in accordance with the UE cooperation configuration. In some examples, the message may be a feedback message based on the downlink message.

At 445, in some examples, the UE 115-f may receive deactivation signaling from the base station 105-a. The deactivation signaling may indicate a deactivation of UE cooperation between the UE 115-f and the UE 115-g. In some examples, the deactivation signaling may include a first field indicating the deactivation of the UE cooperation, a second field indicating the ID of the UE 115-f and the ID of the UE 115-g, a third field indicating a type of the UE cooperation to be deactivated, or any combination thereof.

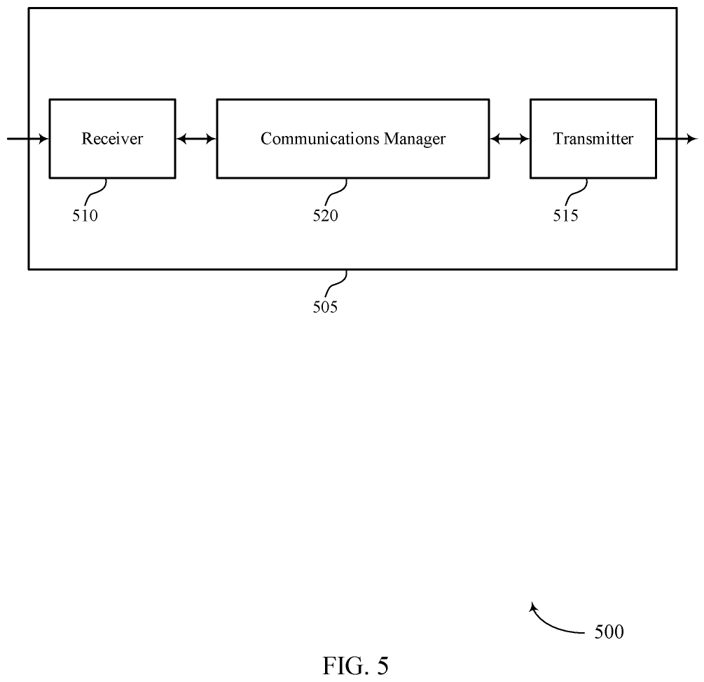

FIG. 5 shows a block diagram 500 of a device 505 that supports configuration for UE cooperation in accordance with aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to configuration for UE cooperation). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to configuration for UE cooperation). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of configuration for UE cooperation as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a central processing unit (CPU), an ASIC, an FPGA, or any combination of these or other programmable logic devices (e.g., configured as or otherwise supporting a means for performing the functions described in the present disclosure).

In some examples, the communications manager 520 may be configured to perform various operations (e.g., receiving, monitoring, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to receive information, transmit information, or perform various other operations as described herein.

The communications manager 520 may support wireless communications at a first UE in accordance with examples as disclosed herein. For example, the communications manager 520 may be configured as or otherwise support a means for receiving, from a base station, first control signaling indicating an active communication configuration between the first UE and the base station. The communications manager 520 may be configured as or otherwise support a means for receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The communications manager 520 may be configured as or otherwise support a means for identifying, from the set of multiple antenna panels, an antenna panel for reception of a downlink message from the base station based on the UE cooperation configuration. The communications manager 520 may be configured as or otherwise support a means for transmitting a message to the base station, the second UE, or both in response to the downlink message and in accordance with the UE cooperation configuration.

By including or configuring the communications manager 520 in accordance with examples as described herein, the device 505 (e.g., a processor controlling or otherwise coupled to the receiver 510, the transmitter 515, the communications manager 520, or a combination thereof) may support techniques for reduced processing, reduced power consumption, and more efficient utilization of communication resources. By receiving the UE cooperation configuration indicating the ID of the second UE and at least the portion of the active communication configuration between the second UE and the base station, the device 505 (e.g., a UE 115) may be configured to be associated with the ID of the second UE 115. As such, the processor of the device 505 may monitor for DCI scheduling downlink messages for the device 505 or the second UE, which may support more efficient utilization of communication resources. The processor may additionally or alternatively receive downlink messages from the base station, the second UE, or both, which may reduce processing and power consumption while operating according to the UE cooperation configuration.

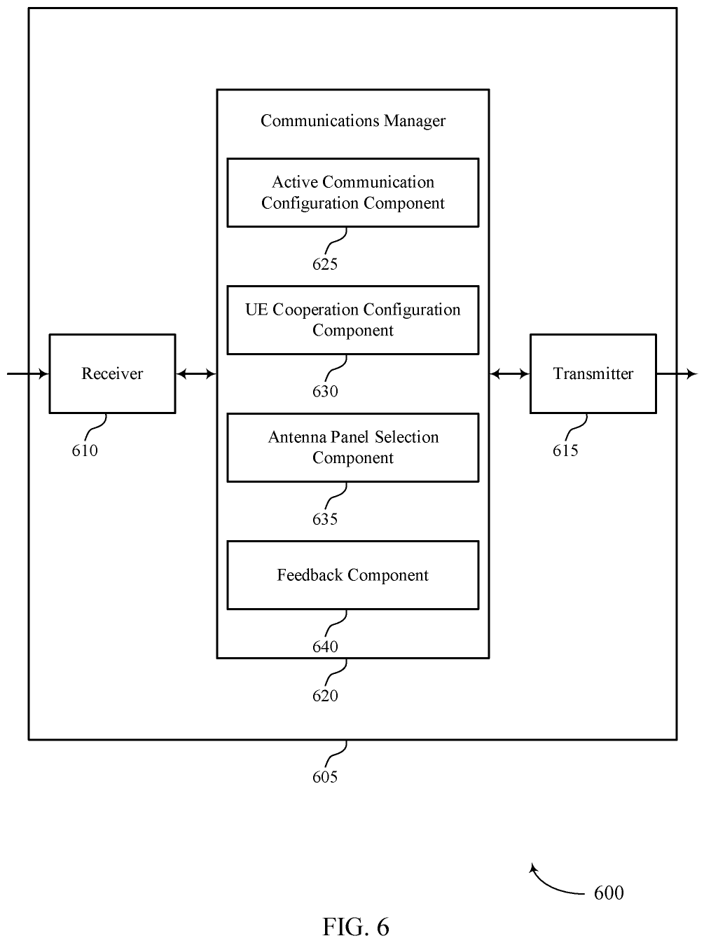

FIG. 6 shows a block diagram 600 of a device 605 that supports configuration for UE cooperation in accordance with aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to configuration for UE cooperation). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to configuration for UE cooperation). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of configuration for UE cooperation as described herein. For example, the communications manager 620 may include an active communication configuration component 625, a UE cooperation configuration component 630, an antenna panel selection component 635, a feedback component 640, or any combination thereof. The communications manager 620 may be an example of aspects of a communications manager 520 as described herein. In some examples, the communications manager 620, or various components thereof, may be configured to perform various operations (e.g., receiving, monitoring, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to receive information, transmit information, or perform various other operations as described herein.

The communications manager 620 may support wireless communications at a first UE in accordance with examples as disclosed herein. The active communication configuration component 625 may be configured as or otherwise support a means for receiving, from a base station, first control signaling indicating an active communication configuration between the first UE and the base station. The UE cooperation configuration component 630 may be configured as or otherwise support a means for receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The antenna panel selection component 635 may be configured as or otherwise support a means for identifying, from the set of multiple antenna panels, an antenna panel for reception of a downlink message from the base station based on the UE cooperation configuration. The feedback component 640 may be configured as or otherwise support a means for transmitting a message to the base station, the second UE, or both in response to the downlink message and in accordance with the UE cooperation configuration.

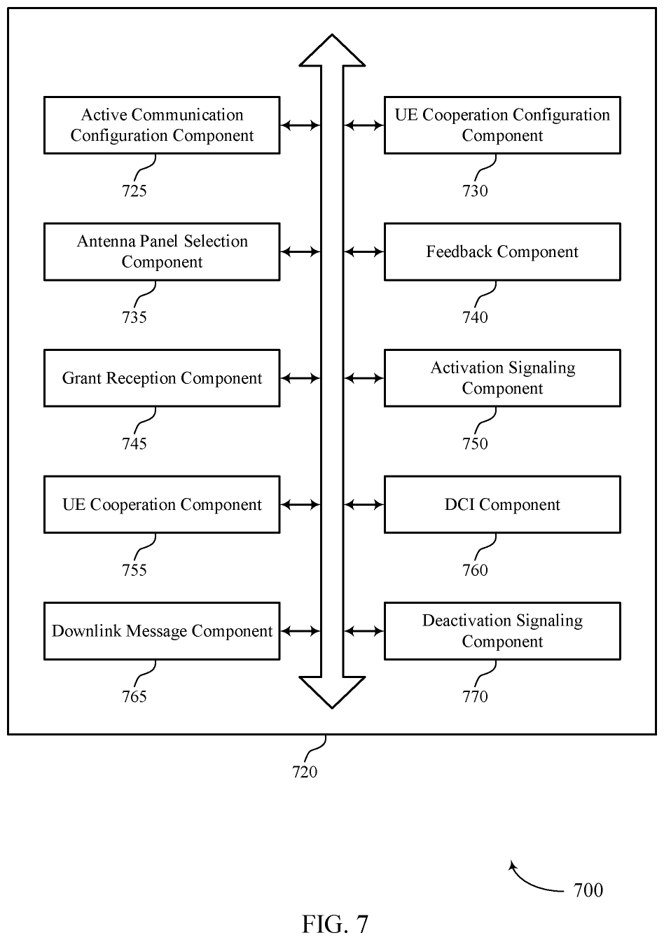

FIG. 7 shows a block diagram 700 of a communications manager 720 that supports configuration for UE cooperation in accordance with aspects of the present disclosure. The communications manager 720 may be an example of aspects of a communications manager 520, a communications manager 620, or both, as described herein. The communications manager 720, or various components thereof, may be an example of means for performing various aspects of configuration for UE cooperation as described herein. For example, the communications manager 720 may include an active communication configuration component 725, a UE cooperation configuration component 730, an antenna panel selection component 735, a feedback component 740, a grant reception component 745, an activation signaling component 750, a UE cooperation component 755, a DCI component 760, a downlink message component 765, a deactivation signaling component 770, or any combination thereof. Each of these components may communicate, directly or indirectly, with one another (e.g., via one or more buses).

The communications manager 720 may support wireless communications at a first UE in accordance with examples as disclosed herein. The active communication configuration component 725 may be configured as or otherwise support a means for receiving, from a base station, first control signaling indicating an active communication configuration between the first UE and the base station. The UE cooperation configuration component 730 may be configured as or otherwise support a means for receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The antenna panel selection component 735 may be configured as or otherwise support a means for identifying, from the set of multiple antenna panels, an antenna panel for reception of a downlink message from the base station based on the UE cooperation configuration. The feedback component 740 may be configured as or otherwise support a means for transmitting a message to the base station, the second UE, or both in response to the downlink message and in accordance with the UE cooperation configuration.

In some examples, to support identifying the antenna panel from the set of multiple antenna panels, the grant reception component 745 may be configured as or otherwise support a means for receiving, from the base station, a grant scheduling the downlink message, where the grant indicates an ID of the first UE or the ID of the second UE. In some examples, to support identifying the antenna panel from the set of multiple antenna panels, the antenna panel selection component 735 may be configured as or otherwise support a means for identifying, from a first antenna panel corresponding to the first UE and a second antenna panel corresponding to the second UE, the antenna panel for reception of the downlink message in accordance with the grant.

In some examples, to support receiving the grant, the DCI component 760 may be configured as or otherwise support a means for receiving DCI including a CIF set to a first value corresponding to the ID of the first UE or a second value corresponding to the ID of the second UE. In some examples, to support receiving the grant, the antenna panel selection component 735 may be configured as or otherwise support a means for identifying the antenna panel in accordance with the CIF.

In some examples, to support receiving the grant, the DCI component 760 may be configured as or otherwise support a means for receiving DCI including CRC information scrambled by a first C-RNTI corresponding to the ID of the first UE or scrambled by a second C-RNTI corresponding to the ID of the second UE. In some examples, to support receiving the grant, the antenna panel selection component 735 may be configured as or otherwise support a means for identifying the antenna panel in accordance with the first C-RNTI or the second C-RNTI.

In some examples, the grant indicates the ID of the first UE, and the downlink message component 765 may be configured as or otherwise support a means for receiving the downlink message at the first antenna panel corresponding to the first UE in accordance with the grant. In some examples, the grant indicates the ID of the first UE, and the feedback component 740 may be configured as or otherwise support a means for transmitting, to the base station, the message in response to the downlink message, where the message includes a feedback message corresponding to the downlink message.

In some examples, the active communication configuration between the first UE and the base station includes an RRC configuration between the first UE and the base station. In some examples, the active communication configuration between the second UE and the base station includes an RRC configuration between the second UE and the base station. In some examples, the second control signaling includes an RRC reconfiguration message indicating the ID of the second UE and the portion of the active communication configuration between the second UE and the base station. In some examples, the portion of the active communication configuration between the second UE and the base station includes a DCI format corresponding to the second UE, a type of the RRC configuration between the second UE and the base station, or both.

In some examples, the ID of the second UE includes one of a C-RNTI, an antenna panel ID, a serving cell index, a CORESET ID, or a component carrier ID. In some examples, the type of the RRC configuration between the second UE and the base station includes a downlink shared channel configuration, a downlink control channel configuration, an uplink shared channel configuration, an uplink control channel configuration, or a combination thereof.

In some examples, the activation signaling component 750 may be configured as or otherwise support a means for receiving activation signaling indicating an activation of UE cooperation between the first UE and the second UE in accordance with the UE cooperation configuration, where the activation signaling includes a first field indicating the activation of the UE cooperation, a second field indicating an ID of the first UE and the ID of the second UE, a third field indicating a type of the UE cooperation to be activated, or a combination thereof. In some examples, the UE cooperation component 755 may be configured as or otherwise support a means for communicating, in response to the activation signaling, with the base station, with the second UE, or both in accordance with the UE cooperation configuration.

In some examples, the deactivation signaling component 770 may be configured as or otherwise support a means for receiving deactivation signaling indicating a deactivation of the UE cooperation between the first UE and the second UE, where the deactivation signaling includes the first field indicating the deactivation of the UE cooperation, the second field indicating the ID of the first UE and the ID of the second UE, the third field indicating the type of the UE cooperation to be deactivated, or a combination thereof.

In some examples, the type of the UE cooperation corresponds to cooperation for uplink communications, downlink communications, communications via an uplink control channel, communications via a downlink control channel, or a combination thereof. In some examples, the activation signaling component 750 may be configured as or otherwise support a means for receiving the activation signaling via a first MAC-CE. In some examples, the deactivation signaling component 770 may be configured as or otherwise support a means for receiving the deactivation signaling via a second MAC-CE.

In some examples, the UE cooperation component 755 may be configured as or otherwise support a means for transmitting, to the base station, a request for UE cooperation with the second UE in accordance with a UE cooperation negotiation procedure performed between the first UE and the second UE. In some examples, the UE cooperation component 755 may be configured as or otherwise support a means for receiving the second control signaling in response to transmitting the request for UE cooperation.

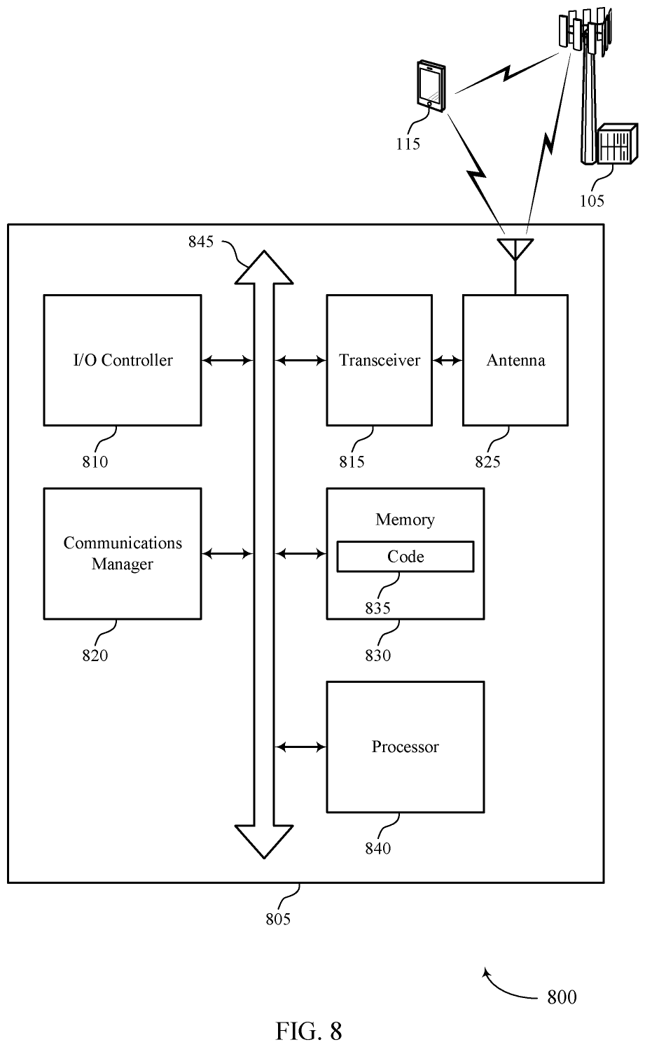

FIG. 8 shows a diagram of a system 800 including a device 805 that supports configuration for UE cooperation in accordance with aspects of the present disclosure. The device 805 may be an example of or include the components of a device 505, a device 605, or a UE 115 as described herein. The device 805 may communicate wirelessly with one or more base stations 105, UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting configuration for UE cooperation). For example, the device 805 or a component of the device 805 may include a processor 840 and memory 830 coupled to the processor 840, the processor 840 and memory 830 configured to perform various functions described herein.

The communications manager 820 may support wireless communications at a first UE in accordance with examples as disclosed herein. For example, the communications manager 820 may be configured as or otherwise support a means for receiving, from a base station, first control signaling indicating an active communication configuration between the first UE and the base station. The communications manager 820 may be configured as or otherwise support a means for receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The communications manager 820 may be configured as or otherwise support a means for identifying, from the set of multiple antenna panels, an antenna panel for reception of a downlink message from the base station based on the UE cooperation configuration. The communications manager 820 may be configured as or otherwise support a means for transmitting a message to the base station, the second UE, or both in response to the downlink message and in accordance with the UE cooperation configuration.

By including or configuring the communications manager 820 in accordance with examples as described herein, the device 805 may support techniques for improved communication reliability, reduced latency, and improved coordination between devices. The UE cooperation configuration for the device 805 (e.g., a UE) may provide for improved coordination between the device 805 and at least a second device (e.g., a second UE) while performing UE cooperation. For example, the UE cooperation configuration may indicate, to the device 805, an ID of the second device and at least a portion of an active communication configuration for the second device. The device 805 may use the indicated information to perform accurate and reliable communications with the second device, a base station, or both. By operating as a distributed unit, the device 805 and the second device may reduce latency associated with communications between the devices and the base station.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of configuration for UE cooperation as described herein, or the processor 840 and the memory 830 may be otherwise configured to perform or support such operations.

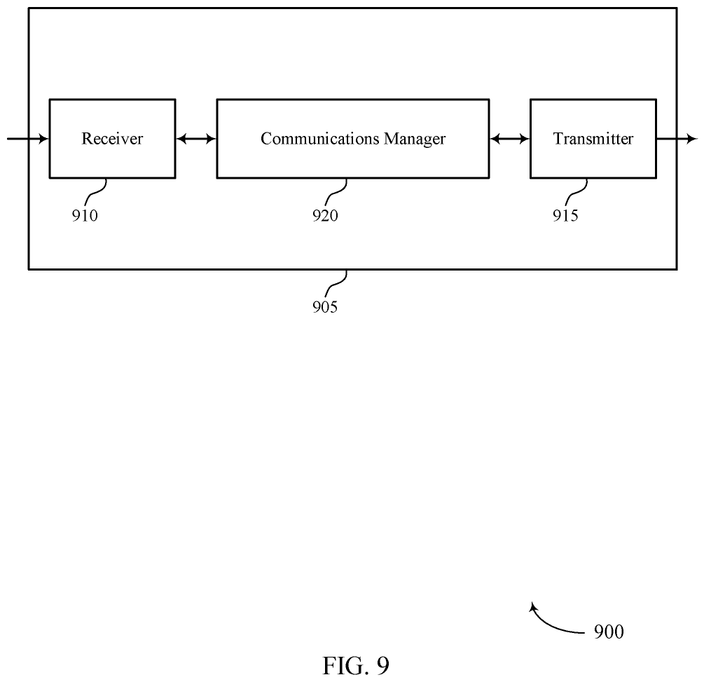

FIG. 9 shows a block diagram 900 of a device 905 that supports configuration for UE cooperation in accordance with aspects of the present disclosure. The device 905 may be an example of aspects of a base station 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for receiving information such as packets, user data, control information, or any combination thereof associated with various information channels (e.g., control channels, data channels, information channels related to configuration for UE cooperation). Information may be passed on to other components of the device 905. The receiver 910 may utilize a single antenna or a set of multiple antennas.

The transmitter 915 may provide a means for transmitting signals generated by other components of the device 905. For example, the transmitter 915 may transmit information such as packets, user data, control information, or any combination thereof associated with various information channels (e.g., control channels, data channels, information channels related to configuration for UE cooperation). In some examples, the transmitter 915 may be co-located with a receiver 910 in a transceiver module. The transmitter 915 may utilize a single antenna or a set of multiple antennas.

The communications manager 920, the receiver 910, the transmitter 915, or various combinations thereof or various components thereof may be examples of means for performing various aspects of configuration for UE cooperation as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, an ASIC, an FPGA or other programmable logic device, a discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, or any combination of these or other programmable logic devices (e.g., configured as or otherwise supporting a means for performing the functions described in the present disclosure).

In some examples, the communications manager 920 may be configured to perform various operations (e.g., receiving, monitoring, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to receive information, transmit information, or perform various other operations as described herein.

The communications manager 920 may support wireless communications at a base station in accordance with examples as disclosed herein. For example, the communications manager 920 may be configured as or otherwise support a means for transmitting, to a first UE, first control signaling indicating an active communication configuration between the first UE and the base station. The communications manager 920 may be configured as or otherwise support a means for transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The communications manager 920 may be configured as or otherwise support a means for transmitting, to the first UE using an antenna panel of the set of multiple antenna panels, a downlink message in accordance with the UE cooperation configuration.

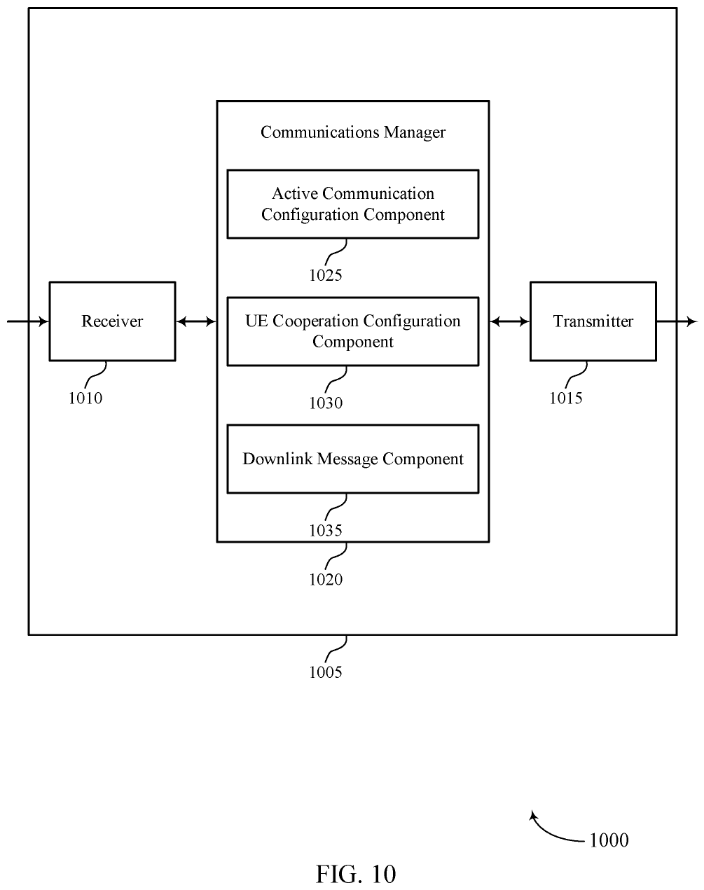

FIG. 10 shows a block diagram 1000 of a device 1005 that supports configuration for UE cooperation in accordance with aspects of the present disclosure. The device 1005 may be an example of aspects of a device 905 or a base station 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to configuration for UE cooperation). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to configuration for UE cooperation). In some examples, the transmitter 1015 may be co-located with a receiver 1010 in a transceiver module. The transmitter 1015 may utilize a single antenna or a set of multiple antennas.

The device 1005, or various components thereof, may be an example of means for performing various aspects of configuration for UE cooperation as described herein. For example, the communications manager 1020 may include an active communication configuration component 1025, a UE cooperation configuration component 1030, a downlink message component 1035, or any combination thereof. The communications manager 1020 may be an example of aspects of a communications manager 920 as described herein. In some examples, the communications manager 1020, or various components thereof, may be configured to perform various operations (e.g., receiving, monitoring, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to receive information, transmit information, or perform various other operations as described herein.

The communications manager 1020 may support wireless communications at a base station in accordance with examples as disclosed herein. The active communication configuration component 1025 may be configured as or otherwise support a means for transmitting, to a first UE, first control signaling indicating an active communication configuration between the first UE and the base station. The UE cooperation configuration component 1030 may be configured as or otherwise support a means for transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The downlink message component 1035 may be configured as or otherwise support a means for transmitting, to the first UE using an antenna panel of the set of multiple antenna panels, a downlink message in accordance with the UE cooperation configuration.

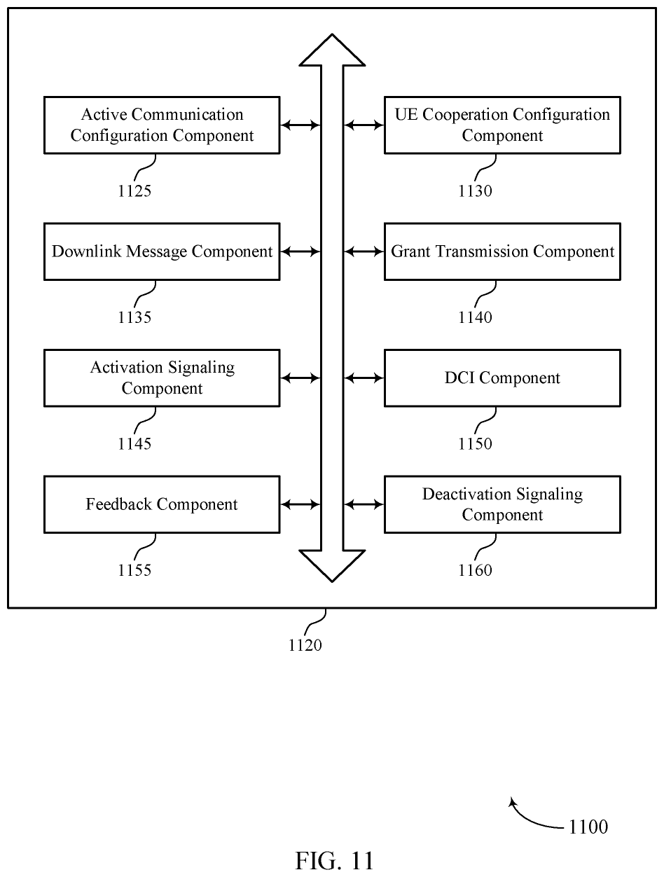

FIG. 11 shows a block diagram 1100 of a communications manager 1120 that supports configuration for UE cooperation in accordance with aspects of the present disclosure. The communications manager 1120 may be an example of aspects of a communications manager 920, a communications manager 1020, or both, as described herein. The communications manager 1120, or various components thereof, may be an example of means for performing various aspects of configuration for UE cooperation as described herein. For example, the communications manager 1120 may include an active communication configuration component 1125, a UE cooperation configuration component 1130, a downlink message component 1135, a grant transmission component 1140, an activation signaling component 1145, a DCI component 1150, a feedback component 1155, a deactivation signaling component 1160, or any combination thereof. Each of these components may communicate, directly or indirectly, with one another (e.g., via one or more buses).

The communications manager 1120 may support wireless communications at a base station in accordance with examples as disclosed herein. The active communication configuration component 1125 may be configured as or otherwise support a means for transmitting, to a first UE, first control signaling indicating an active communication configuration between the first UE and the base station. The UE cooperation configuration component 1130 may be configured as or otherwise support a means for transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The downlink message component 1135 may be configured as or otherwise support a means for transmitting, to the first UE using an antenna panel of the set of multiple antenna panels, a downlink message in accordance with the UE cooperation configuration.

In some examples, the grant transmission component 1140 may be configured as or otherwise support a means for transmitting, to the first UE, a grant scheduling the downlink message, where the grant indicates an ID of the first UE or the ID of the second UE. In some examples, the downlink message component 1135 may be configured as or otherwise support a means for transmitting the downlink message using a first antenna panel corresponding to the first UE or a second antenna panel corresponding to the second UE in accordance with the grant.

In some examples, to support transmitting the grant, the DCI component 1150 may be configured as or otherwise support a means for transmitting, to the first UE, DCI including a CIF set to a first value corresponding to the ID of the first UE or a second value corresponding to the ID of the second UE. In some examples, to support transmitting the grant, the downlink message component 1135 may be configured as or otherwise support a means for transmitting the downlink message using the first antenna panel or the second antenna panel in accordance with the CIF.

In some examples, to support transmitting the grant, the DCI component 1150 may be configured as or otherwise support a means for transmitting DCI including CRC information scrambled by a first C-RNTI corresponding to the ID of the first UE or scrambled by a second C-RNTI corresponding to the ID of the second UE. In some examples, to support transmitting the grant, the downlink message component 1135 may be configured as or otherwise support a means for transmitting the downlink message using the first antenna panel or the second antenna panel in accordance with the first C-RNTI or the second C-RNTI.

In some examples, the downlink message component 1135 may be configured as or otherwise support a means for transmitting the downlink message using the first antenna panel corresponding to the first UE. In some examples, the feedback component 1155 may be configured as or otherwise support a means for receiving, from the first UE, a feedback message in response to the downlink message.

In some examples, the downlink message component 1135 may be configured as or otherwise support a means for transmitting the downlink message using the second antenna panel corresponding to the second UE. In some examples, the feedback component 1155 may be configured as or otherwise support a means for receiving, from the second UE, a feedback message in response to the downlink message.

In some examples, the active communication configuration between the first UE and the base station includes an RRC configuration between the first UE and the base station. In some examples, the active communication configuration between the second UE and the base station includes an RRC configuration between the second UE and the base station. In some examples, the second control signaling includes an RRC reconfiguration message indicating the ID of the second UE and the portion of the active communication configuration between the second UE and the base station. In some examples, the portion of the active communication configuration between the second UE and the base station includes a DCI format corresponding to the second UE, a type of the RRC configuration between the second UE and the base station, or both.

In some examples, the ID of the second UE includes one of a C-RNTI, an antenna panel ID, a serving cell index, a CORESET ID, or a component carrier ID. In some examples, the type of the RRC configuration between the second UE and the base station includes a downlink shared channel configuration, a downlink control channel configuration, an uplink shared channel configuration, an uplink control channel configuration, or a combination thereof.

In some examples, the activation signaling component 1145 may be configured as or otherwise support a means for transmitting activation signaling indicating an activation of UE cooperation between the first UE and the second UE in accordance with the UE cooperation configuration, where the activation signaling includes a first field indicating the activation of the UE cooperation, a second field indicating an ID of the first UE and the ID of the second UE, a third field indicating a type of the UE cooperation to be activated, or a combination thereof.

In some examples, the deactivation signaling component 1160 may be configured as or otherwise support a means for transmitting deactivation signaling indicating a deactivation of the UE cooperation between the first UE and the second UE, where the deactivation signaling includes the first field indicating the deactivation of the UE cooperation, the second field indicating the ID of the first UE and the ID of the second UE, the third field indicating the type of the UE cooperation to be deactivated, or a combination thereof.

In some examples, the type of the UE cooperation corresponds to cooperation for uplink communications, downlink communications, communications via an uplink control channel, communications via a downlink control channel, or a combination thereof. In some examples, the activation signaling component 1145 may be configured as or otherwise support a means for transmitting the activation signaling via a first MAC-CE. In some examples, the deactivation signaling component 1160 may be configured as or otherwise support a means for transmitting the deactivation signaling via a second MAC-CE.

In some examples, the UE cooperation configuration component 1130 may be configured as or otherwise support a means for receiving, from the first UE, a request for UE cooperation with the second UE in accordance with a UE cooperation negotiation procedure performed between the first UE and the second UE. In some examples, the UE cooperation configuration component 1130 may be configured as or otherwise support a means for transmitting the second control signaling to the first UE in response to the request for UE cooperation.

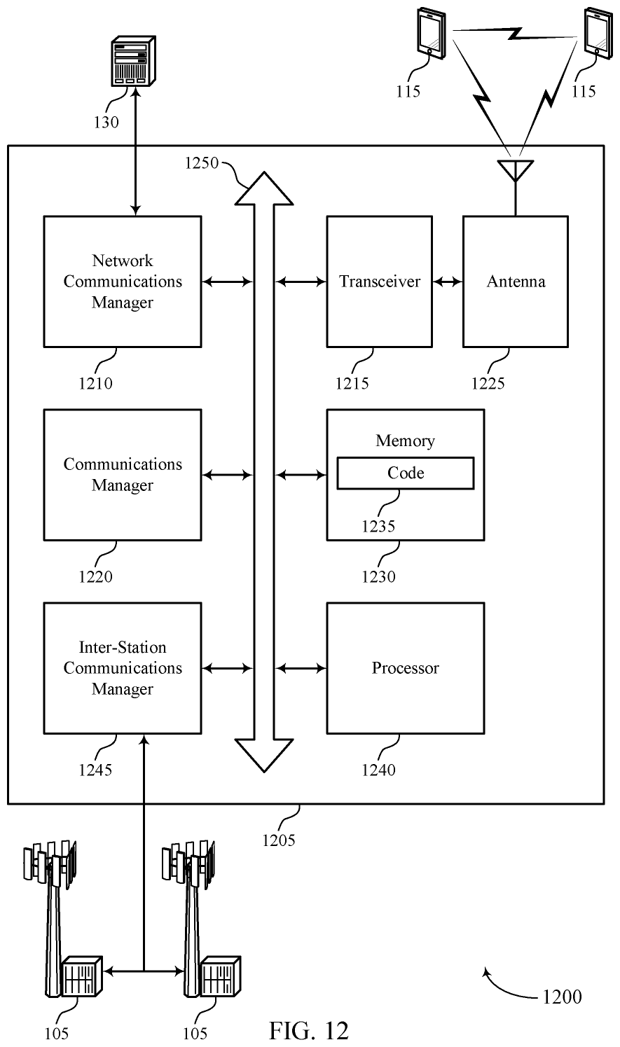

FIG. 12 shows a diagram of a system 1200 including a device 1205 that supports configuration for UE cooperation in accordance with aspects of the present disclosure. The device 1205 may be an example of or include the components of a device 905, a device 1005, or a base station 105 as described herein. The device 1205 may communicate wirelessly with one or more base stations 105, UEs 115, or any combination thereof. The device 1205 may include components for bi-directional voice and data communications including components for transmitting and receiving communications, such as a communications manager 1220, a network communications manager 1210, a transceiver 1215, an antenna 1225, a memory 1230, code 1235, a processor 1240, and an inter-station communications manager 1245. These components may be in electronic communication or otherwise coupled (e.g., operatively, communicatively, functionally, electronically, electrically) via one or more buses (e.g., a bus 1250).

The network communications manager 1210 may manage communications with a core network 130 (e.g., via one or more wired backhaul links). For example, the network communications manager 1210 may manage the transfer of data communications for client devices, such as one or more UEs 115.

In some cases, the device 1205 may include a single antenna 1225. However, in some other cases the device 1205 may have more than one antenna 1225, which may be capable of concurrently transmitting or receiving multiple wireless transmissions. The transceiver 1215 may communicate bi-directionally, via the one or more antennas 1225, wired, or wireless links as described herein. For example, the transceiver 1215 may represent a wireless transceiver and may communicate bi-directionally with another wireless transceiver. The transceiver 1215 may also include a modem to modulate the packets, to provide the modulated packets to one or more antennas 1225 for transmission, and to demodulate packets received from the one or more antennas 1225. The transceiver 1215, or the transceiver 1215 and one or more antennas 1225, may be an example of a transmitter 915, a transmitter 1015, a receiver 910, a receiver 1010, or any combination thereof or component thereof, as described herein.

The memory 1230 may include RAM and ROM. The memory 1230 may store computer-readable, computer-executable code 1235 including instructions that, when executed by the processor 1240, cause the device 1205 to perform various functions described herein. The code 1235 may be stored in a non-transitory computer-readable medium such as system memory or another type of memory. In some cases, the code 1235 may not be directly executable by the processor 1240 but may cause a computer (e.g., when compiled and executed) to perform functions described herein. In some cases, the memory 1230 may contain, among other things, a BIOS which may control basic hardware or software operation such as the interaction with peripheral components or devices.

The processor 1240 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1240 may be configured to operate a memory array using a memory controller. In some other cases, a memory controller may be integrated into the processor 1240. The processor 1240 may be configured to execute computer-readable instructions stored in a memory (e.g., the memory 1230) to cause the device 1205 to perform various functions (e.g., functions or tasks supporting configuration for UE cooperation). For example, the device 1205 or a component of the device 1205 may include a processor 1240 and memory 1230 coupled to the processor 1240, the processor 1240 and memory 1230 configured to perform various functions described herein.

The inter-station communications manager 1245 may manage communications with other base stations 105, and may include a controller or scheduler for controlling communications with UEs 115 in cooperation with other base stations 105. For example, the inter-station communications manager 1245 may coordinate scheduling for transmissions to UEs 115 for various interference mitigation techniques such as beamforming or joint transmission. In some examples, the inter-station communications manager 1245 may provide an X2 interface within an LTE/LTE-A wireless communications network technology to provide communication between base stations 105.

The communications manager 1220 may support wireless communications at a base station in accordance with examples as disclosed herein. For example, the communications manager 1220 may be configured as or otherwise support a means for transmitting, to a first UE, first control signaling indicating an active communication configuration between the first UE and the base station. The communications manager 1220 may be configured as or otherwise support a means for transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The communications manager 1220 may be configured as or otherwise support a means for transmitting, to the first UE using an antenna panel of the set of multiple antenna panels, a downlink message in accordance with the UE cooperation configuration.

In some examples, the communications manager 1220 may be configured to perform various operations (e.g., receiving, monitoring, transmitting) using or otherwise in cooperation with the transceiver 1215, the one or more antennas 1225, or any combination thereof. Although the communications manager 1220 is illustrated as a separate component, in some examples, one or more functions described with reference to the communications manager 1220 may be supported by or performed by the processor 1240, the memory 1230, the code 1235, or any combination thereof. For example, the code 1235 may include instructions executable by the processor 1240 to cause the device 1205 to perform various aspects of configuration for UE cooperation as described herein, or the processor 1240 and the memory 1230 may be otherwise configured to perform or support such operations.

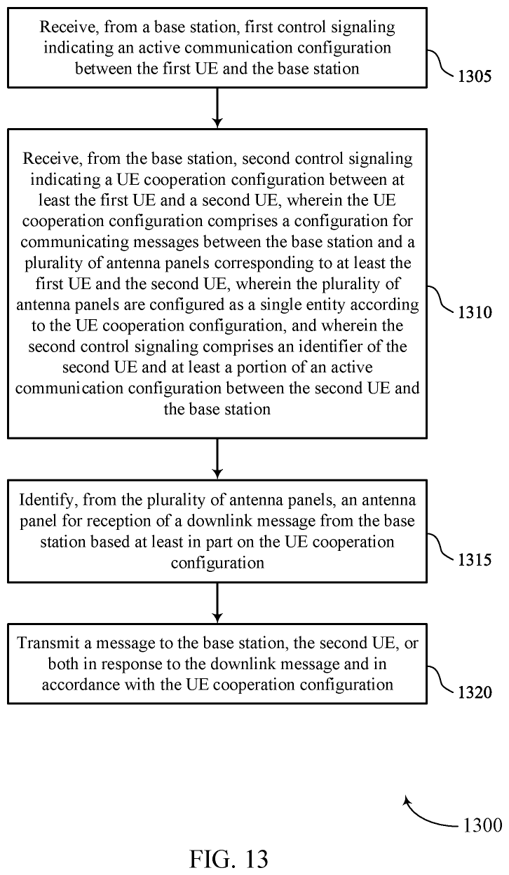

FIG. 13 shows a flowchart illustrating a method 1300 that supports configuration for UE cooperation in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1305, the method may include receiving, from a base station, first control signaling indicating an active communication configuration between the first UE and the base station. The operations of 1305 may be performed in accordance with examples as disclosed herein. In some examples, aspects of the operations of 1305 may be performed by an active communication configuration component 725 as described with reference to FIG. 7.

At 1310, the method may include receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The operations of 1310 may be performed in accordance with examples as disclosed herein. In some examples, aspects of the operations of 1310 may be performed by a UE cooperation configuration component 730 as described with reference to FIG. 7.

At 1315, the method may include identifying, from the set of multiple antenna panels, an antenna panel for reception of a downlink message from the base station based on the UE cooperation configuration. The operations of 1315 may be performed in accordance with examples as disclosed herein. In some examples, aspects of the operations of 1315 may be performed by an antenna panel selection component 735 as described with reference to FIG. 7.

At 1320, the method may include transmitting a message to the base station, the second UE, or both in response to the downlink message and in accordance with the UE cooperation configuration. The operations of 1320 may be performed in accordance with examples as disclosed herein. In some examples, aspects of the operations of 1320 may be performed by a feedback component 740 as described with reference to FIG. 7.

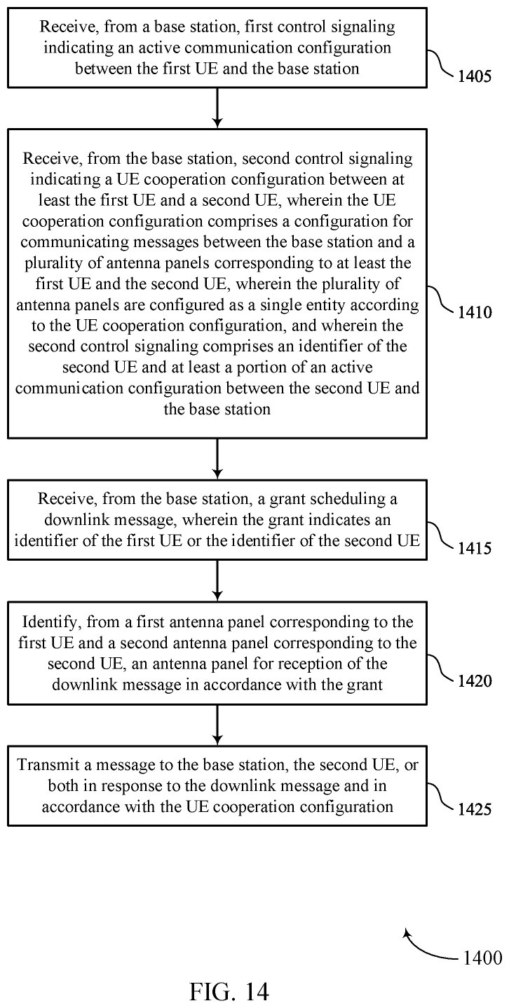

FIG. 14 shows a flowchart illustrating a method 1400 that supports configuration for UE cooperation in accordance with aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally or alternatively, the UE may perform aspects of the described functions using special-purpose hardware.

At 1405, the method may include receiving, from a base station, first control signaling indicating an active communication configuration between the first UE and the base station. The operations of 1405 may be performed in accordance with examples as disclosed herein. In some examples, aspects of the operations of 1405 may be performed by an active communication configuration component 725 as described with reference to FIG. 7.

At 1410, the method may include receiving, from the base station, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The operations of 1410 may be performed in accordance with examples as disclosed herein. In some examples, aspects of the operations of 1410 may be performed by a UE cooperation configuration component 730 as described with reference to FIG. 7.

At 1415, the method may include receiving, from the base station, a grant scheduling a downlink message, where the grant indicates an ID of the first UE or the ID of the second UE. The operations of 1415 may be performed in accordance with examples as disclosed herein. In some examples, aspects of the operations of 1415 may be performed by a grant reception component 745 as described with reference to FIG. 7.

At 1420, the method may include identifying, from a first antenna panel corresponding to the first UE and a second antenna panel corresponding to the second UE, an antenna panel for reception of a downlink message in accordance with the grant. The operations of 1420 may be performed in accordance with examples as disclosed herein. In some examples, aspects of the operations of 1420 may be performed by an antenna panel selection component 735 as described with reference to FIG. 7.

At 1425, the method may include transmitting a message to the base station, the second UE, or both in response to the downlink message and in accordance with the UE cooperation configuration. The operations of 1425 may be performed in accordance with examples as disclosed herein. In some examples, aspects of the operations of 1425 may be performed by a feedback component 740 as described with reference to FIG. 7.

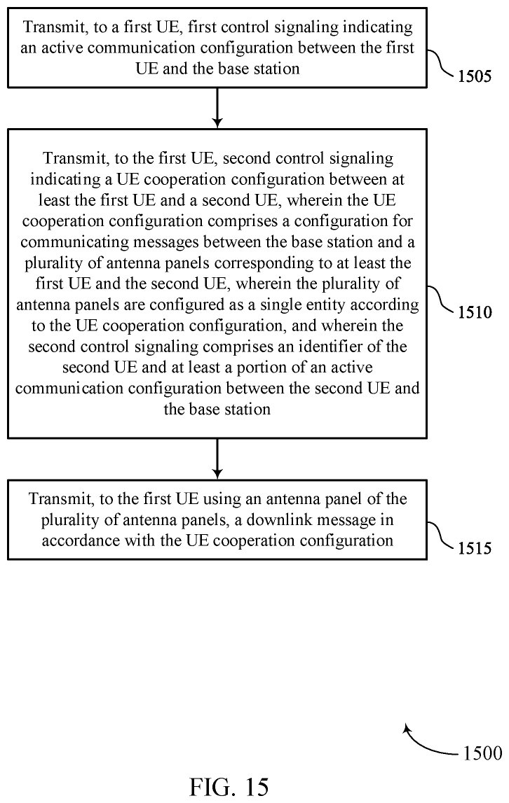

FIG. 15 shows a flowchart illustrating a method 1500 that supports configuration for UE cooperation in accordance with aspects of the present disclosure. The operations of the method 1500 may be implemented by a base station or its components as described herein. For example, the operations of the method 1500 may be performed by a base station 105 as described with reference to FIGS. 1 through 4 and 9 through 12. In some examples, a base station may execute a set of instructions to control the functional elements of the base station to perform the described functions. Additionally or alternatively, the base station may perform aspects of the described functions using special-purpose hardware.

At 1505, the method may include transmitting, to a first UE, first control signaling indicating an active communication configuration between the first UE and the base station. The operations of 1505 may be performed in accordance with examples as disclosed herein. In some examples, aspects of the operations of 1505 may be performed by an active communication configuration component 1125 as described with reference to FIG. 11.

At 1510, the method may include transmitting, to the first UE, second control signaling indicating a UE cooperation configuration between at least the first UE and a second UE, where the UE cooperation configuration includes a configuration for communicating messages between the base station and a set of multiple antenna panels corresponding to at least the first UE and the second UE, where the set of multiple antenna panels are configured as a single entity according to the UE cooperation configuration, and where the second control signaling includes an ID of the second UE and at least a portion of an active communication configuration between the second UE and the base station. The operations of 1510 may be performed in accordance with examples as disclosed herein. In some examples, aspects of the operations of 1510 may be performed by a UE cooperation configuration component 1130 as described with reference to FIG. 11.

At 1515, the method may include transmitting, to the first UE using an antenna panel of the set of multiple antenna panels, a downlink message in accordance with the UE cooperation configuration. The operations of 1515 may be performed in accordance with examples as disclosed herein. In some examples, aspects of the operations of 1515 may be performed by a downlink message component 1135 as described with reference to FIG. 11.

The following provides an overview of aspects of the present disclosure:
Aspect 1: A method for wireless communications at a first UE, comprising: receiving, from a base station, first control signaling indicating an active communication configuration between the first UE and the base station; receiving, from the base station, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station; identifying, from the plurality of antenna panels, an antenna panel for reception of a downlink message from the base station based at least in part on the UE cooperation configuration; and transmitting a message to the base station, the second UE, or both in response to the downlink message and in accordance with the UE cooperation configuration.
Aspect 2: The method of aspect 1, wherein identifying the antenna panel from the plurality of antenna panels further comprises: receiving, from the base station, a grant scheduling the downlink message, wherein the grant indicates an identifier of the first UE or the identifier of the second UE; and identifying, from a first antenna panel corresponding to the first UE and a second antenna panel corresponding to the second UE, the antenna panel for reception of the downlink message in accordance with the grant.
Aspect 3: The method of aspect 2, wherein receiving the grant further comprises: receiving downlink control information comprising a cell index field set to a first value corresponding to the identifier of the first UE or a second value corresponding to the identifier of the second UE; and identifying the antenna panel in accordance with the cell index field.
Aspect 4: The method of aspect 2, wherein receiving the grant further comprises: receiving downlink control information comprising cyclic redundancy check information scrambled by a first control radio network temporary identifier corresponding to the identifier of the first UE or scrambled by a second control radio network temporary identifier corresponding to the identifier of the second UE; and identifying the antenna panel in accordance with the first control radio network temporary identifier or the second control radio network temporary identifier.
Aspect 5: The method of any of aspects 2 through 4, wherein the grant indicates the identifier of the first UE, the method further comprising: receiving the downlink message at the first antenna panel corresponding to the first UE in accordance with the grant; and transmitting, to the base station, the message in response to the downlink message, wherein the message comprises a feedback message corresponding to the downlink message.
Aspect 6: The method of any of aspects 1 through 5, wherein: the active communication configuration between the first UE and the base station comprises a radio resource control configuration between the first UE and the base station; the active communication configuration between the second UE and the base station comprises a radio resource control configuration between the second UE and the base station; the second control signaling comprises a radio resource control reconfiguration message indicating the identifier of the second UE and the portion of the active communication configuration between the second UE and the base station; and the portion of the active communication configuration between the second UE and the base station comprises a downlink control information format corresponding to the second UE, a type of the radio resource control configuration between the second UE and the base station, or both.
Aspect 7: The method of aspect 6, wherein the identifier of the second UE comprises one of a control radio network temporary identifier, an antenna panel identifier, a serving cell index, a control resource set identifier, or a component carrier identifier.
Aspect 8: The method of any of aspects 6 through 7, wherein the type of the radio resource control configuration between the second UE and the base station comprises a downlink shared channel configuration, a downlink control channel configuration, an uplink shared channel configuration, an uplink control channel configuration, or a combination thereof.
Aspect 9: The method of any of aspects 1 through 8, further comprising: receiving activation signaling indicating an activation of UE cooperation between the first UE and the second UE in accordance with the UE cooperation configuration, wherein the activation signaling comprises a first field indicating the activation of the UE cooperation, a second field indicating an identifier of the first UE and the identifier of the second UE, a third field indicating a type of the UE cooperation to be activated, or a combination thereof; and communicating, in response to the activation signaling, with the base station, with the second UE, or both in accordance with the UE cooperation configuration.
Aspect 10: The method of aspect 9, further comprising: receiving deactivation signaling indicating a deactivation of the UE cooperation between the first UE and the second UE, wherein the deactivation signaling comprises the first field indicating the deactivation of the UE cooperation, the second field indicating the identifier of the first UE and the identifier of the second UE, the third field indicating the type of the UE cooperation to be deactivated, or a combination thereof
Aspect 11: The method of aspect 10, wherein the type of the UE cooperation corresponds to cooperation for uplink communications, downlink communications, communications via an uplink control channel, communications via a downlink control channel, or a combination thereof
Aspect 12: The method of any of aspects 10 through 11, further comprising: receiving the activation signaling via a first medium access control control element; and receiving the deactivation signaling via a second medium access control control element.
Aspect 13: The method of any of aspects 1 through 12, further comprising: transmitting, to the base station, a request for UE cooperation with the second UE in accordance with a UE cooperation negotiation procedure performed between the first UE and the second UE; and receiving the second control signaling in response to transmitting the request for UE cooperation.
Aspect 14: A method for wireless communications at a base station, comprising: transmitting, to a first UE, first control signaling indicating an active communication configuration between the first UE and the base station; transmitting, to the first UE, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station; and transmitting, to the first UE using an antenna panel of the plurality of antenna panels, a downlink message in accordance with the UE cooperation configuration.
Aspect 15: The method of aspect 14, further comprising: transmitting, to the first UE, a grant scheduling the downlink message, wherein the grant indicates an identifier of the first UE or the identifier of the second UE; and transmitting the downlink message using a first antenna panel corresponding to the first UE or a second antenna panel corresponding to the second UE in accordance with the grant.
Aspect 16: The method of aspect 15, wherein transmitting the grant further comprises: transmitting, to the first UE, downlink control information comprising a cell index field set to a first value corresponding to the identifier of the first UE or a second value corresponding to the identifier of the second UE; and transmitting the downlink message using the first antenna panel or the second antenna panel in accordance with the cell index field.
Aspect 17: The method of aspect 15, wherein transmitting the grant further comprises: transmitting downlink control information comprising cyclic redundancy check information scrambled by a first control radio network temporary identifier corresponding to the identifier of the first UE or scrambled by a second control radio network temporary identifier corresponding to the identifier of the second UE; and transmitting the downlink message using the first antenna panel or the second antenna panel in accordance with the first control radio network temporary identifier or the second control radio network temporary identifier.
Aspect 18: The method of any of aspects 15 through 17, further comprising: transmitting the downlink message using the first antenna panel corresponding to the first UE; and receiving, from the first UE, a feedback message in response to the downlink message.
Aspect 19: The method of any of aspects 15 through 17, further comprising: transmitting the downlink message using the second antenna panel corresponding to the second UE; and receiving, from the second UE, a feedback message in response to the downlink message.
Aspect 20: The method of any of aspects 14 through 19, wherein: the active communication configuration between the first UE and the base station comprises a radio resource control configuration between the first UE and the base station; the active communication configuration between the second UE and the base station comprises a radio resource control configuration between the second UE and the base station; the second control signaling comprises a radio resource control reconfiguration message indicating the identifier of the second UE and the portion of the active communication configuration between the second UE and the base station; and the portion of the active communication configuration between the second UE and the base station comprises a downlink control information format corresponding to the second UE, a type of the radio resource control configuration between the second UE and the base station, or both.
Aspect 21: The method of aspect 20, wherein the identifier of the second UE comprises one of a control radio network temporary identifier, an antenna panel identifier, a serving cell index, a control resource set identifier, or a component carrier identifier.
Aspect 22: The method of any of aspects 20 through 21, wherein the type of the radio resource control configuration between the second UE and the base station comprises a downlink shared channel configuration, a downlink control channel configuration, an uplink shared channel configuration, an uplink control channel configuration, or a combination thereof.
Aspect 23: The method of any of aspects 14 through 22, further comprising: transmitting activation signaling indicating an activation of UE cooperation between the first UE and the second UE in accordance with the UE cooperation configuration, wherein the activation signaling comprises a first field indicating the activation of the UE cooperation, a second field indicating an identifier of the first UE and the identifier of the second UE, a third field indicating a type of the UE cooperation to be activated, or a combination thereof.
Aspect 24: The method of aspect 23, further comprising: transmitting deactivation signaling indicating a deactivation of the UE cooperation between the first UE and the second UE, wherein the deactivation signaling comprises the first field indicating the deactivation of the UE cooperation, the second field indicating the identifier of the first UE and the identifier of the second UE, the third field indicating the type of the UE cooperation to be deactivated, or a combination thereof
Aspect 25: The method of aspect 24, wherein the type of the UE cooperation corresponds to cooperation for uplink communications, downlink communications, communications via an uplink control channel, communications via a downlink control channel, or a combination thereof
Aspect 26: The method of any of aspects 24 through 25, further comprising: transmitting the activation signaling via a first medium access control control element; and transmitting the deactivation signaling via a second medium access control control element.
Aspect 27: The method of any of aspects 14 through 26, further comprising: receiving, from the first UE, a request for UE cooperation with the second UE in accordance with a UE cooperation negotiation procedure performed between the first UE and the second UE; and transmitting the second control signaling to the first UE in response to the request for UE cooperation.
Aspect 28: An apparatus for wireless communications at a first UE, comprising a processor; memory coupled with the processor; and instructions stored in the memory and executable by the processor to cause the apparatus to perform a method of any of aspects 1 through 13.
Aspect 29: An apparatus for wireless communications at a first UE, comprising at least one means for performing a method of any of aspects 1 through 13.
Aspect 30: A non-transitory computer-readable medium storing code for wireless communications at a first UE, the code comprising instructions executable by a processor to perform a method of any of aspects 1 through 13.
Aspect 31: An apparatus for wireless communications at a base station, comprising a processor; memory coupled with the processor; and instructions stored in the memory and executable by the processor to cause the apparatus to perform a method of any of aspects 14 through 27.
Aspect 32: An apparatus for wireless communications at a base station, comprising at least one means for performing a method of any of aspects 14 through 27.
Aspect 33: A non-transitory computer-readable medium storing code for wireless communications at a base station, the code comprising instructions executable by a processor to perform a method of any of aspects 14 through 27.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a wide variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a first user equipment (UE), comprising:
receiving, from a base station, first control signaling indicating an active communication configuration between the first UE and the base station;
receiving, from the base station, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station;
identifying, from the plurality of antenna panels, an antenna panel for reception of a downlink message from the base station based at least in part on the UE cooperation configuration; and
transmitting a message to the base station, the second UE, or both in response to the downlink message and in accordance with the UE cooperation configuration.

2. The method of claim 1, wherein identifying the antenna panel from the plurality of antenna panels further comprises:
receiving, from the base station, a grant scheduling the downlink message, wherein the grant indicates an identifier of the first UE or the identifier of the second UE; and
identifying, from a first antenna panel corresponding to the first UE and a second antenna panel corresponding to the second UE, the antenna panel for reception of the downlink message in accordance with the grant.

3. The method of claim 2, wherein receiving the grant further comprises:
receiving downlink control information comprising a cell index field set to a first value corresponding to the identifier of the first UE or a second value corresponding to the identifier of the second UE; and
identifying the antenna panel in accordance with the cell index field.

4. The method of claim 2, wherein receiving the grant further comprises:
receiving downlink control information comprising cyclic redundancy check information scrambled by a first control radio network temporary identifier corresponding to the identifier of the first UE or scrambled by a second control radio network temporary identifier corresponding to the identifier of the second UE; and
identifying the antenna panel in accordance with the first control radio network temporary identifier or the second control radio network temporary identifier.

5. The method of claim 2, wherein the grant indicates the identifier of the first UE, the method further comprising:
receiving the downlink message at the first antenna panel corresponding to the first UE in accordance with the grant; and
transmitting, to the base station, the message in response to the downlink message, wherein the message comprises a feedback message corresponding to the downlink message.

6. The method of claim 1, wherein:
the active communication configuration between the first UE and the base station comprises a radio resource control configuration between the first UE and the base station;
the active communication configuration between the second UE and the base station comprises a radio resource control configuration between the second UE and the base station;
the second control signaling comprises a radio resource control reconfiguration message indicating the identifier of the second UE and the portion of the active communication configuration between the second UE and the base station; and
the portion of the active communication configuration between the second UE and the base station comprises a downlink control information format corresponding to the second UE, a type of the radio resource control configuration between the second UE and the base station, or both.

7. The method of claim 6, wherein the identifier of the second UE comprises one of a control radio network temporary identifier, an antenna panel identifier, a serving cell index, a control resource set identifier, or a component carrier identifier.

8. The method of claim 6, wherein the type of the radio resource control configuration between the second UE and the base station comprises a downlink shared channel configuration, a downlink control channel configuration, an uplink shared channel configuration, an uplink control channel configuration, or a combination thereof.

9. The method of claim 1, further comprising:
receiving activation signaling indicating an activation of UE cooperation between the first UE and the second UE in accordance with the UE cooperation configuration, wherein the activation signaling comprises a first field indicating the activation of the UE cooperation, a second field indicating an identifier of the first UE and the identifier of the second UE, a third field indicating a type of the UE cooperation to be activated, or a combination thereof; and
communicating, in response to the activation signaling, with the base station, with the second UE, or both in accordance with the UE cooperation configuration.

10. The method of claim 9, further comprising:
receiving deactivation signaling indicating a deactivation of the UE cooperation between the first UE and the second UE, wherein the deactivation signaling comprises the first field indicating the deactivation of the UE cooperation, the second field indicating the identifier of the first UE and the identifier of the second UE, the third field indicating the type of the UE cooperation to be deactivated, or a combination thereof.

11. The method of claim 10, wherein the type of the UE cooperation corresponds to cooperation for uplink communications, downlink communications, communications via an uplink control channel, communications via a downlink control channel, or a combination thereof.

12. The method of claim 10, further comprising:
receiving the activation signaling via a first medium access control control element; and
receiving the deactivation signaling via a second medium access control control element.

13. The method of claim 1, further comprising:
transmitting, to the base station, a request for UE cooperation with the second UE in accordance with a UE cooperation negotiation procedure performed between the first UE and the second UE; and
receiving the second control signaling in response to transmitting the request for UE cooperation.

14. A method for wireless communications at a base station, comprising:
transmitting, to a first user equipment (UE), first control signaling indicating an active communication configuration between the first UE and the base station;
transmitting, to the first UE, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station; and
transmitting, to the first UE using an antenna panel of the plurality of antenna panels, a downlink message in accordance with the UE cooperation configuration.

15. The method of claim 14, further comprising:
transmitting, to the first UE, a grant scheduling the downlink message, wherein the grant indicates an identifier of the first UE or the identifier of the second UE; and
transmitting the downlink message using a first antenna panel corresponding to the first UE or a second antenna panel corresponding to the second UE in accordance with the grant.

16. The method of claim 15, wherein transmitting the grant further comprises:
transmitting, to the first UE, downlink control information comprising a cell index field set to a first value corresponding to the identifier of the first UE or a second value corresponding to the identifier of the second UE; and
transmitting the downlink message using the first antenna panel or the second antenna panel in accordance with the cell index field.

17. The method of claim 15, wherein transmitting the grant further comprises:
transmitting downlink control information comprising cyclic redundancy check information scrambled by a first control radio network temporary identifier corresponding to the identifier of the first UE or scrambled by a second control radio network temporary identifier corresponding to the identifier of the second UE; and
transmitting the downlink message using the first antenna panel or the second antenna panel in accordance with the first control radio network temporary identifier or the second control radio network temporary identifier.

18. The method of claim 15, further comprising:
transmitting the downlink message using the first antenna panel corresponding to the first UE; and
receiving, from the first UE, a feedback message in response to the downlink message.

19. The method of claim 15, further comprising:
transmitting the downlink message using the second antenna panel corresponding to the second UE; and
receiving, from the second UE, a feedback message in response to the downlink message.

20. The method of claim 14, wherein:
the active communication configuration between the first UE and the base station comprises a radio resource control configuration between the first UE and the base station;
the active communication configuration between the second UE and the base station comprises a radio resource control configuration between the second UE and the base station;
the second control signaling comprises a radio resource control reconfiguration message indicating the identifier of the second UE and the portion of the active communication configuration between the second UE and the base station; and
the portion of the active communication configuration between the second UE and the base station comprises a downlink control information format corresponding to the second UE, a type of the radio resource control configuration between the second UE and the base station, or both.

21. The method of claim 20, wherein the identifier of the second UE comprises one of a control radio network temporary identifier, an antenna panel identifier, a serving cell index, a control resource set identifier, or a component carrier identifier.

22. The method of claim 20, wherein the type of the radio resource control configuration between the second UE and the base station comprises a downlink shared channel configuration, a downlink control channel configuration, an uplink shared channel configuration, an uplink control channel configuration, or a combination thereof.

23. The method of claim 14, further comprising:
transmitting activation signaling indicating an activation of UE cooperation between the first UE and the second UE in accordance with the UE cooperation configuration, wherein the activation signaling comprises a first field indicating the activation of the UE cooperation, a second field indicating an identifier of the first UE and the identifier of the second UE, a third field indicating a type of the UE cooperation to be activated, or a combination thereof.

24. The method of claim 23, further comprising:
transmitting deactivation signaling indicating a deactivation of the UE cooperation between the first UE and the second UE, wherein the deactivation signaling comprises the first field indicating the deactivation of the UE cooperation, the second field indicating the identifier of the first UE and the identifier of the second UE, the third field indicating the type of the UE cooperation to be deactivated, or a combination thereof.

25. The method of claim 24, wherein the type of the UE cooperation corresponds to cooperation for uplink communications, downlink communications, communications via an uplink control channel, communications via a downlink control channel, or a combination thereof.

26. The method of claim 24, further comprising:
transmitting the activation signaling via a first medium access control control element; and
transmitting the deactivation signaling via a second medium access control control element.

27. The method of claim 14, further comprising:
receiving, from the first UE, a request for UE cooperation with the second UE in accordance with a UE cooperation negotiation procedure performed between the first UE and the second UE; and
transmitting the second control signaling to the first UE in response to the request for UE cooperation.

28. An apparatus for wireless communications at a first user equipment (UE), comprising:
a processor;
memory coupled with the processor; and
instructions stored in the memory and executable by the processor to cause the apparatus to:
receive, from a base station, first control signaling indicating an active communication configuration between the first UE and the base station;
receive, from the base station, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station;
identify, from the plurality of antenna panels, an antenna panel for reception of a downlink message from the base station based at least in part on the UE cooperation configuration; and
transmit a message to the base station, the second UE, or both in response to the downlink message and in accordance with the UE cooperation configuration.

29. The apparatus of claim 28, wherein the instructions to identify the antenna panel from the plurality of antenna panels are further executable by the processor to cause the apparatus to:
receive, from the base station, a grant scheduling the downlink message, wherein the grant indicates an identifier of the first UE or the identifier of the second UE; and
identify, from a first antenna panel corresponding to the first UE and a second antenna panel corresponding to the second UE, the antenna panel for reception of the downlink message in accordance with the grant.

30. An apparatus for wireless communications at a base station, comprising:
a processor;
memory coupled with the processor; and
instructions stored in the memory and executable by the processor to cause the apparatus to:
transmit, to a first user equipment (UE), first control signaling indicating an active communication configuration between the first UE and the base station;
transmit, to the first UE, second control signaling indicating a UE cooperation configuration between at least the first UE and a second UE, wherein the UE cooperation configuration comprises a configuration for communicating messages between the base station and a plurality of antenna panels corresponding to at least the first UE and the second UE, wherein the plurality of antenna panels are configured as a single entity according to the UE cooperation configuration, and wherein the second control signaling comprises an identifier of the second UE and at least a portion of an active communication configuration between the second UE and the base station; and
transmit, to the first UE using an antenna panel of the plurality of antenna panels, a downlink message in accordance with the UE cooperation configuration.
